(19) United States
(12) Patent Application Publication
(10) Pub. No.: US 2008/0220360 A1
(43) Pub. Date: Sep. 11, 2008

(54) TONER, AND TWO-COMPONENT DEVELOPER AND IMAGE FORMING APPARATUS USING THE TONER

(76) Inventor: Kumi HASEGAWA, Numazu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/042,538

(22) Filed: Mar. 5, 2008

(30) Foreign Application Priority Data
Mar. 5, 2007 (JP) 2007-054574

(51) Int. Cl. G03G 9/087; G03G 15/06

(52) U.S. Cl. 430/109.3; 399/222

(57) ABSTRACT

A toner including a binder resin including a polyester resin containing an inorganic tin(II) compound as a catalyst, a magnetic material, and a hydrophobized particulate inorganic material, wherein the toner has a magnetization of from 10 to 25 emu/g in a magnetic field of 5 kOe, and a tan δ, which is a ratio of a loss elastic modulus (G″) to a storage elastic modulus (G′), of from 0.7 to 1.3 when measured by a rheometer at a frequency of 0.1 Hz and a temperature 30° C. higher than a glass transition temperature of the toner.

### BACKGROUND OF THE INVENTION

1. Field of the Invention

The present invention relates to a toner for use in electrophotography. In addition, the present invention also relates to a two-component developer and an image forming apparatus using the toner.

2. Discussion of the Background

In electrophotography, an image is typically formed as follows:
(1) an electrostatic latent image is formed on an electrostatic latent image bearing member including a photoconductive substance;
(2) the electrostatic latent image is developed with a toner to form a toner image;
(3) the toner image is transferred onto a recording medium such as paper; and
(4) the toner image is fixed on the recording medium by application of heat, solvent vapor, etc.

Developing methods are broadly classified into wet developing methods using a wet developer and dry developing methods using a toner in which a colorant is dispersed in a binder resin or a two-component developer in which a toner and carrier are mixed. The dry developing methods have been widely used recently because of having a relatively long life and being capable of high-speed printing. Therefore, the dry developing methods are widely used in middle-speed and high-speed copiers and printers.

Copy images and print images are strongly desired to have high definition and high resolution. In attempting to obtain such a high-definition and high-resolution image, toners have improved to have a small particle diameter.

In a case where a toner includes a large amount of small toner particles, particularly in a recent compact developing device, it is difficult to sufficiently transfer the toner from an electrostatic latent image bearing member and to remove toner particles remaining on the electrostatic latent image bearing member. When such a toner is used for a two-component developer including a carrier, toner particles not used for the development tend to accumulate on the surface of the carrier, resulting in a short life of the two-component developer. (This phenomenon is hereinafter referred to as “spent carrier problem”.)

In attempting to prevent occurrence of the spent carrier problem, techniques of covering the surface of a carrier with various resins have been proposed. For example, carriers covered with a styrene-methacrylate copolymer, a styrene polymer, etc., have been proposed. These carriers have good chargeability. However, the lives thereof are not so long because these carriers have a relatively high critical surface tension.

As another example, a carrier covered with an ethylene tetrafluoride copolymer is proposed. Such a carrier hardly causes the spent carrier problem because of having a low surface tension. However, such a carrier cannot negatively charge a toner because the ethylene tetrafluoride copolymer is located on the most negative side in the frictional charging series.

As an example for a carrier having a low surface tension, a carrier covered with a cover layer including a silicone resin is proposed. For example, U.S. Pat. No. 3,627,522 discloses a carrier covered with a styrene-acrylate and/or styrene-methacrylate resin mixed with an organosilane, a silanol, a siloxane, etc. Published unexamined Japanese patent application No. (hereinafter referred to as JP-A) 55-157751 discloses a carrier covered with a modified silicone resin.

The above-described carriers having a cover layer including a silicone resin have better resistance to the spent carrier problem. However, these carriers do not satisfactorily respond to a demand of long developer life, particularly when used with a toner including a large amount of toner particles having a particle diameter not greater than 5 μm.

JP-A 10-91000 discloses a one-component developing device using a toner including a small amount of toner particles having a particle diameter not greater than 5 μm. However, no mention is made of the particle diameter distribution within a range most toner particles exist, which contributes to the resultant image quality. Moreover, the use of such a toner is limited to a one-component developing method.

In the one-component developing method, a developing sleeve bears a toner owing to an electric force generated by friction between the toner and the developing sleeve or a magnetic force generated between the toner including a magnetic material and the developing sleeve containing a magnet. When an attraction force in which an electric field formed by the electrostatic latent image attracts the toner from the developing sleeve to the electrostatic latent image overcomes the binding force between the toner and the developing sleeve, the toner adheres to the electrostatic latent image. Thus, a toner image is formed.

There is no need to control the toner concentration in the one-component developing method. Therefore, a one-component developing device has the advantage of being small in size. However, there is a disadvantage that the developed amount of toner particles (i.e., the amount of toner particles adhered to the image bearing member) is not satisfactory, because a smaller amount of toner particles are supplied to the developing area compared to the two-component developing method. For this reason, the one-component developing method is not suitable for use in high-speed copiers.

In attempting to solve the above-described problem of the one-component developing method, published examined Japanese patent application No. (hereinafter referred to as JP-B) 05-67233 discloses a two-component developing device in which a two-component developer (hereinafter refereed to as a developer) present at the periphery of a developing sleeve incorporates a toner at a toner supplying part and the developer is controlled by a layer thickness control member to charge the toner. This developing device does not need a toner supplying mechanism and a toner concentration detector. However, the amount of the developer cannot be increased compared to a conventional two-component developing device, and therefore the toner cannot be satisfactorily charged particularly in a high-speed machine in which the developing sleeve has a high linear velocity. As a result, background fouling is caused, wherein the background portion of an image is soiled with toner particles.

In order to satisfactorily charge the toner, the layer thickness control member needs to apply a strong stress to the developer. Thereby, developer particles collide with each other and heat is generated. As a result, a toner film is formed on the surface of the carrier (i.e., the spent carrier problem). Chargeability of such a spent carrier deteriorates with time and causes toner scattering and background fouling.

When the developer is used for a compact developing device, the developer needs to quickly charge the supplied toner. Therefore, a large amount of fluidity improving agent is added to the toner so that the supplied toner and the carrier are quickly mixed. When such a developer is repeatedly used, the fluidity improving agent tends to strongly adhere to the image bearing member, resulting in production of abnormal images having undesired lines.

When a larger stress is applied to the developer when being agitated, not only the spent toner problem but also a charge-up phenomenon is caused, in which a toner is excessively charged. Since a compact developing device contains a small amount of developer and toner, the toner concentration in the developer varies widely when an image having a large image proportion is continuously produced and a large amount of toner is consumed. As a result, the resultant image density decreases.

In such a developing device, the toner concentration has variations between portions where the developer actively moves or not, or portions where a large or small amount of the developer are present, because each of the portions incorporates a different amount of the toner. Therefore, the resultant image tends to have density unevenness and fog. JP-A 63-4282 discloses a developing device in which two toner supply members are provided in a toner hopper. It is disclosed therein that by passing a developer through a path formed by the toner supply members, the occurrence of image density unevenness or fog in a longitudinal direction of the device can be prevented. However, the use of two toner supply members causes upsizing of the developing unit and increasing the manufacturing cost.

In such a developing device, in which the amount of incorporated toner is self-controlled by the motion of the developer, the weight average particle diameter and the particle diameter distribution of the toner is very important. When the toner includes too large an amount of toner particles having a particle diameter not greater than 5 μm, the toner has poor fluidity. In this case, the toner cannot be stably incorporated in the developer. In contrast, when the toner includes a large amount of coarse particles, the substantial amount of incorporated toner decreases. In this case, the resultant image density decreases particularly when an image having a large image proportion is produced.

To solve the above problem, JP-A 2002-372801 discloses a toner having a specific magnetization and a particle diameter distribution and an image forming method using the toner. Although the initial toner is capable of producing high quality images, the toner deteriorates with time because a fluidity improving agent is buried in the surface of the toner due to application of stress in the developing part. Environmental stability of the toner also deteriorates. Therefore, such a toner cannot stably produce high quality images particularly in an image forming system which needs no toner concentration detector.

### SUMMARY OF THE INVENTION

Accordingly, an object of the present invention is to provide a toner and a developer having a good combination of environmental stability, temporal stability, and chargeability.

Another object of the present invention is to provide an image forming apparatus capable of producing high quality images with good reproducibility of thin lines and halftone images without causing white spots resulting from transfer defect and background fouling resulting from insufficient cleaning of an image bearing member.

These and other objects of the present invention, either individually or in combinations thereof, as hereinafter will become more readily apparent can be attained by a toner, comprising:

a binder resin comprising a polyester resin comprising an inorganic tin(II) compound as a catalyst;

a magnetic material; and

a hydrophobized particulate inorganic material,

wherein the toner has a magnetization of from 10 to 25 emu/g in a magnetic field of 5 kOe, and wherein the toner has a tan δ, which is a ratio of a loss elastic modulus (G″) to a storage elastic modulus (G′) , of from 0.7 to 1.3 when measured by a rheometer at a frequency of 0.1 Hz and a temperature 30° C. higher than a glass transition temperature of the toner;

and a two-component developer and an image forming apparatus using the toner.

### BRIEF DESCRIPTION OF THE DRAWINGS

These and other objects, features and advantages of the present invention will become apparent upon consideration of the following description of the preferred embodiments of the present invention taken in conjunction with the accompanying drawings, wherein:

FIG. 1 is a schematic view illustrating an embodiment of a developing device for use in the image forming apparatus of the present invention; and

FIGS. 2 to 4 are schematic views explaining the behavior of the developer of the present invention in a developing device for use in the image forming apparatus of the present invention.

### DETAILED DESCRIPTION OF THE INVENTION

### (Toner)

The toner of the present invention comprises a binder resin, a magnetic material, and a hydrophobized particulate inorganic material, and optionally includes a release agent, a charge controlling agent, and the like, if desired.

The toner of the present invention has a magnetization of from 10 to 25 emu/g, and preferably from 15 to 20 emu/g, in a magnetic field of 5 kOe.

When the magnetization in a magnetic field of 5 kOe is too small, fog tends to be caused in the resultant image. When the magnetization in a magnetic field of 5 kOe is too large, the toner is hardly used for development of a latent image due to magnetic bias effect.

The magnetization in a magnetic field of 5 kOe of a toner can be measured using a magnetization measuring instrument such as BHU-60 (from Riken Denshi Co., Ltd.), for example, as follows. A cell having an inner diameter of 7 mm and a height of 10 mm is charged with a toner. A hysteresis curve is obtained by sweeping at a magnetic field of 5 kOe. The saturated magnetization can be determined from the hysteresis curve.

The toner of the present invention has a magnetization of from 7 to 20 emu/g, and preferably from 10 to 17 emu/g, in a magnetic field of 1 kOe.

In polymer rheology, a melted polymer in rubbery region alters its behavior according to the deformation velocity. When the deformation is quickly performed, i.e., when the deformation frequency is high, the melted polymer has a high elastic modulus comparable to a glassy solid. In contrast, when the deformation is slowly performed, i.e., when the deformation frequency is low, the melted polymer behaves like a viscous fluid.

The toner of the present invention has a tan δ, which is a ratio of a loss elastic modulus (G″) to a storage elastic modulus (G′) , of from 0.7 to 1.3 when measured by a rheometer at a frequency of 0.1 Hz and a temperature 30° C. higher than a glass transition temperature of the toner. When the tan δ is too small, the toner has too large an elasticity, i.e., the toner is too hard. Such a toner tends to deteriorate a cleaning blade made of an elastic rubber and shorten the life thereof. When such a toner is manufactured by a pulverization method, pulverization efficiency deteriorates. As a result, a wax tends to be exposed to the pulverized sections. The resultant toner has a large adhesive property and tends to form toner films on a photoreceptor or a carrier. In contrast, when the tan δ is too large, the toner has too large a viscosity. Such a toner easily deforms by application of stress in a developing device. In addition, an external additive tends to be buried in the toner, resulting in deterioration of fluidity of the toner. In particular, when a toner concentration detector is not provided in the image forming system used, image density unevenness and background fouling tend to be caused.

The toner of the present invention having the above-described rheological properties is obtained by including a polyester resin containing an inorganic tin(II) compound as a catalyst as a binder resin. When an organic catalyst is used for synthesizing a polyester resin, monomers and oligomers of organic molecules derived from the organic catalyst are dispersed in the resultant resin. If such a polyester resin is used for a toner, the toner may have a tan δ greater than 1.3, because the polyester resin may partially soften. Moreover, water tends to adsorb to the monomers and oligomers of the organic molecules derived from the organic catalyst. As a result, the resultant toner has unstable chargeability, and therefore background fouling and image density unevenness are caused in the resultant image.

In order to obtain a toner having a tan δ of from 0.7 to 1.3 by using a polyester resin synthesized by using an organic catalyst, a larger amount of a magnetic material may be added to the toner as a filler to increase the elasticity of the toner. However, in this case, the toner may have a magnetization greater than 25 emu/g in a magnetic field of 5 kOe while having a desired tan δ.

The toner of the present invention has both desired tan δ and magnetization by including a polyester resin synthesized by using an inorganic tin(II) compound as a catalyst. The toner of the present invention having an appropriate magnetization has stable chargeability. Thereby, high quality images without toner scattering, transfer defect, and background fouling can be stably provided for a long period of time, particularly in an image forming apparatus employing a compact developing device including a developing sleeve and a photoreceptor having small diameters and/or a cleaning device using an elastic rubber blade. In addition, a wax is hardly exposed to the surface (i.e., pulverized section) of the toner of the present invention having appropriate Theological properties. Therefore, the adhesive property of the toner does not increase. As a result, a filming problem in which a toner forms a film thereof on a photoreceptor and the spent carrier problem do not occur even if the toner has a small particle diameter.

Rheological properties of a toner can be measured using a rheometer such as RDA-II (from Rheometric Scientific, Inc.). The measurement conditions are as follows, for example.

Geometry set: parallel plate having a diameter of 7.9 mm

Sample: a heated and melted sample is formed into a columnar shape having a diameter of about 8 mm and a height of from 2 to 5 mm

Measurement frequency: 0.1 Hz

Measurement temperature: 70 to 150° C.

Measurement strain: set the initial value to 0.1% and measured by automatic measurement mode

Elongation correction of sample: by automatic measurement mode

The toner of the present invention comprises a polyester resin containing an inorganic tin(II) compound as a catalyst as a binder resin.

The polyester resin can be obtained from a condensation polymerization between an alcohol and an acid in the presence of the inorganic tin(II) compound as a catalyst.

Specific examples of the alcohols include, but are not limited to, diols (e.g.,polyethyleneglycol, diethyleneglycol, triethyleneglycol, 1,2-propyleneglycol, 1,3-propyleneglycol, 1,4-propylene glycol, neopentyl glycol, 1,4-butenediol), etherified bisphenols (e.g., 1,4-bis(hydroxymethyl)cyclohexane, bisphenol A, hydrogenated bisphenol A, polyoxyethylenated bisphenol A, polyoxypropylenated bisphenol A), the above-mentioned diols substituted with an unsaturated hydrocarbon group having 3 to 22 carbon atoms, and polyols having three or more valences (e.g., sorbitol, 1,2,3,6-hexanetetrol, 1,4-sorbitan, pentaerythritol, dipentaerythritol, tripentaerythritol, sucrose, 1,2,4-butanetriol, trimethylolethane, trimethylolpropane, 1,3,5-trihydroxymethylbenzene). These can be used alone or in combination.

Specific examples of the acids include, but are not limited to, monocarboxylic acids (e.g., palmitic acid, stearic acid, oleic acid); divalent organic acids (e.g., maleic acid, fumaric acid, mesaconic acid, citraconic acid, itaconic acid, glutaconic acid, phthalic acid, isophthalic acid, terephthalic acid, cyclohexanedicarboxylic acid, succinic acid, adipic acid, sebacic acid, malonic acid), these divalent organic acids substituted with an unsaturated hydrocarbon group having 3 to 22 carbon atoms, and acid anhydrides thereof; dimers of a lower alkyl ester and linoleic acid; and polycarboxylic acids having three or more valences (e.g., 1,2,4-benzenetricarboxylic acid, 1,2,5-benzenetricarboxylic acid, 1,2,4-cyclohexanetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, tetra(methylenecarboxyl)methane, 1,2,7,8-octanetetracarboxylic acid) and acid anhydrides thereof. These can be used alone or in combination.

As the inorganic tin(II) compound, compounds having a Sn—O bond and compounds having a Sn—X (X represents a halogen atom) bond are used. Among these compounds, compounds having a Sn—O bond are preferably used.

Specific examples of the compounds having a Sn—O bond include, but are not limited to, tin(II) carboxylates having a carboxyl group having 2 to 28 carbon atoms (e.g., tin(II) octylate, tin(II) oxalate, tin(II) diacetate, tin(II) dioctanoate, tin(II) dilaurate, tin(II) distearate, tin(II) dioleate), dialkoxy tin(II) compounds having an alkoxy group having 2 to 28 carbon atoms (e.g., dioctyloxy tin(II), dilauryloxy tin(II), distearyloxy tin(II), dioleyloxy tin(II)), tin(II) oxide, and tin(II) sulfate.

Specific examples of the compounds having a Sn—X (X represents a halogen atom) bond include, but are not limited to, tin(II) halides (e.g., tin(II) chloride, tin(II) bromide).

In terms of chargeability and catalysis property, fatty acid esters of tin(II) represented by the formula (R⁶COO)₂Sn (R⁶ represents an alkyl or alkenyl group having 5 to 19 carbon atoms), dialkoxy tin(II) compounds represented by the formula (R⁷O)₂Sn (R⁷ represents an alkyl or alkenyl group having 6 to 20 carbon atoms), and tin(II) oxide represented by the formula SnO are preferably used. Among these, fatty acid esters of tin(II) represented by the formula (R⁶COO)₂Sn and tin(II) oxide are more preferably used. Particularly, tin(II) octylate, tin(II) dioctanoate, tin(II) distearate, and tin(II) oxide are much more preferably used, and tin(II) octylate is most preferably used.

The polyester resin for use in the present invention can be prepared by subjecting the alcohol and the acid to a condensation polymerization in the presence of the inorganic tin(II) compound at 180 to 250° C. in an inert gas atmosphere.

The usage of the inorganic tin(II) compound is preferably from 0.001 to 5 parts by weight, and more preferably from 0.05 to 2 parts by weight, based on 100 parts by weight of raw material monomers of a polyester resin. Therefore, the resultant polyester resin containing the inorganic tin(II) compound as a catalyst preferably includes the inorganic tin(II) compound in an amount of from 0.001 to 5 parts by weight, and more preferably from 0.05 to 2 parts by weight, based on 100 parts by weight of the polyester resin.

The binder resin may further include a hybrid resin including a vinyl resin unit and a polyester resin unit containing an inorganic tin(II) compound. In this case, a release agent (e.g., a wax) is well dispersed in the resultant toner. The dispersed release agent particles may be covered with the vinyl resin unit (e.g., a styrene resin unit), and therefore the release agent particles may not be exposed to the surface of the toner. As a result, the life of the developer lengthens.

In this case, the following relationship (1), and preferably the relationship (2), is satisfied:

| | |
|---|---|
| ½B ≦ A ≦ 3B | (1) |
| B ≦ A ≦ 2B | (2) |

wherein A represents the amount of the hybrid resin included in the toner and B represents the amount of the release agent included in the toner. In addition, the amount (B) of the release agent is preferably from 2.5 to 8% by weight based on total amount of the toner. Since the vinyl resin unit of the hybrid resin has a high compatibility with the release agent while the polyester resin unit thereof has a high compatibility with the polyester resin (i.e., the binder resin), the hybrid resin functions as a wax dispersing agent in the toner. Therefore, the release agent is finely dispersed in the polyester resin (the binder resin). As a result, the release agent may not contaminate a developing sleeve.

When a relationship 1/2B>A is satisfied, the amount of the hybrid resin is too small. Therefore, the release agent cannot be finely dispersed in the toner, and contamination of a developing sleeve cannot be prevented. When a relationship A>3B is satisfied, the amount of the hybrid resin is too large, and therefore the hybrid resin and the polyester resin are easily phase-separated. In addition, low-temperature fixability of the toner deteriorates because the amount of the vinyl resin unit increases in the toner.

The binder resin may also include known resins such as homopolymers of styrene or styrene derivatives (e.g., polystyrene, poly-p-chlorostyrene, polyvinyl toluene), styrene copolymers (e.g., styrene-p-chlorostyrene copolymer, styrene-propylene copolymer, styrene-vinyltoluene copolymer, styrene-vinylnaphthalene copolymer, styrene-acrylate copolymer, styrene-methacrylate copolymer, styrene-acrylonitrile copolymer, styrene-vinyl methyl ether copolymer, styrene-vinyl ethyl ether copolymer, styrene-vinyl methyl ketone copolymer, styrene-butadiene copolymer, styrene-isoprene copolymer, styrene-acrylonitrile-indene copolymer), acrylic resin, methacrylic resin, polyvinyl chloride, polyvinyl acetate, polyethylene, polypropylene, polyvinyl butyral, polyacrylic acid resin, rosin, modified rosin, terpene resin, phenol resin, natural-resin-modified phenol resin, natural-resin-modified maleic acid resin, polyurethane, polyamide resin, furan resin, epoxy resin, coumarone-indene resin, silicone resin, aliphatic or alicyclic hydrocarbon resin, and aromatic petroleum resin. These resins can be used alone or in combination.

Specific examples of comonomers of the above-mentioned styrene copolymers include, but are not limited to, monocarboxylic acids having double bond and derivatives thereof (e.g., acrylic acid, methyl acrylate, ethyl acrylate, butyl acrylate, dodecyl acrylate, octyl acrylate, 2-ethylhexyl acrylate, phenyl acrylate, methacrylic acid, methyl methacrylate, ethyl methacrylate, butyl methacrylate, octyl methacrylate, acrylonitrile, methacrylonitrile, acrylamide), dicarboxylic acids having double bond and derivatives thereof (e.g., maleic acid, butyl maleate, methyl maleate, dimethyl maleate), vinyl esters (e.g., vinyl chloride, vinyl acetate, vinyl benzoate), ethylene olefins (e.g., ethylene, propylene, butylene), vinyl ketones (e.g., vinyl methyl ketone, vinyl hexyl ketone), and vinyl ethers (e.g., vinyl methyl ether, vinyl ethyl ether, vinyl isobutyl ether). These can be used alone or in combination.

The toner of the present invention includes a magnetic material, and used as a magnetic toner. Specific examples of the magnetic materials include, but are not limited to, iron oxides (e.g., magnetite, hematite, ferrite); metals (e.g., iron, cobalt, nickel) and alloys thereof with metals such as aluminum, cobalt, copper, lead, magnesium, tin, zinc, antimony, beryllium, bismuth, cadmium, calcium, manganese, selenium, titanium, tungsten, and vanadium; and mixtures thereof. Among these, magnetite is preferably used.

The magnetite can be prepared as follows, for example. At first, an aqueous solution of iron sulfate is neutralized with an alkaline aqueous solution to prepare a suspension of iron hydroxide. The suspension is controlled to have a pH of not less than 10, and subsequently oxidized with a gas including oxygen to prepare a slurry of a magnetite. The slurry was washed with water, and subsequently filtered, dried, and pulverized to prepare magnetite particles.

The magnetic material preferably includes FeO in an amount of from 5 to 50% by weight, and more preferably from 10 to 30% by weight. The magnetic material preferably has a specific surface area of from 1 to 60 m²/g, and more preferably from 3 to 20 m²/g. The magnetic material preferably has an average particle diameter of from 0.01 to 1 μm, and more preferably from 0.1 to 0.5 μm.

The toner preferably includes the magnetic material in an amount of from 5 to 80% by weight, and more preferably from 10 to 60% by weight.

The toner of the present invention further preferably includes a hydrophobized particulate inorganic material.

Specific examples of the hydrophobized particulate inorganic materials include, but are not limited to, the following inorganic materials treated with a hydrophobizing agent: silica, alumina, titanium oxide, barium titanate, magnesium titanate, calcium titanate, strontium titanate, iron oxide, copper oxide, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, and silicon nitride. Among these, hydrophobized silica and hydrophobized titanium oxide are preferably used. In terms of environmental stability and image density stability, a combination of hydrophobized silica particles having an average particle diameter of not greater than 0.05 μm and hydrophobized titanium oxide particles having an average particle diameter of not greater than 0.05 μm is more preferably used.

Specific examples of the hydrophobizing agent include, but are not limited to, silane coupling agents (e.g., dialkyl dihalogenated silane, trialkyl halogenated silane, alkyl trihalogenated silane, hexaalkyl disilazane), silylation agents, silane coupling agents having a fluorinated alkyl group, organic titanate coupling agents, aluminum coupling agents, silicone oils, and silicone varnishes. Among these, silicone oils are preferably used.

Specific examples of the silicone oils include, but are not limited to, methyl silicone oil, dimethyl silicone oil, phenyl silicone oil, chlorophenyl methyl silicone oil, alkyl-modified silicone oil, fatty-acid-modified silicone oil, and polyoxyalkyl-modified silicone oil. Among these, dimethyl silicone oil is preferably used.

Further, specific examples of the hydrophobizing agent include, but are not limited to, dimethyldichlorosilane, trimethylchlorosilane, methyltrichlorosilane, allyldimethyldichlorosilane, allylphenyldichlorosilane, benzyldimethylchlorosilane, bromomethyldimethylchlorosilane, α-chloroethyltrichlorosilane, p-chloroethyltrichlorosilane, chloromethyldimethylchlorosilane, chloromethyltrichlorosilane, p-chlorophenyltrichlorosilane, 3-chloropropyltrichlorosilane, 3-chloropropyltrimethoxysilane, vinyltriethoxysilane, vinylmethoxysilane, vinyl-tris(β-methoxyethoxy)silane, γ-methacryloxypropyltrimethoxysilane, vinyltriacetoxysilane, divinyldichlorosilane, dimethylvinylchlorosilane, octyl-trichlorosilane, decyl-trichlorosilane, nonyl-trichlorosilane, (4-t-propylphenyl)-trichlorosilane, (4-t-butylphenyl)-trichlorosilane, dipentyl-dichlorosilane, dihexyl-dichlorosilane, dioctyl-dichlorosilane, dinonyl-dichlorosilane, didecyl-dichlorosilane, didodecyl-dichlorosilane, dihexadecyl-dichlorosilane, (4-t-butylphenyl)-octyl-dichlorosilane, didecenyl-dichlorosilane, dinoneyl-dichlorosilane, di-2-ethylhexyl-dichlorosilane, di-3,3-dimethylpentyl-dichlorosilane, trihexyl-chlorosilane, trioctyl-chlorosilane, tridecyl-chlorosilane, dioctyl-methyl-chlorosilane, octyl-dimethyl-chlorosilane, (4-t-propylphenyl)-diethyl-chlorosilane, octyltrimethoxysilane, hexamethyldisilazane, hexaethyldisilazane, diethyltetramethyldisilazane, hexaphenyldisilazane, and hexatolyldisilazane. These can be used alone or in combination.

The hydrophobized particulate inorganic material preferably has a primary particle diameter of from 0.02 to 0.1 μm.

The toner preferably includes the hydrophobized particulate inorganic material in an amount of from 0.1 to 2% by weight. When the amount is too small, aggregation of toner particles is not satisfactorily prevented. When the amount is too large, toner scattering is caused in thin line images, inner walls of an image forming apparatus are contaminated, and a photoreceptor is easily scratched or abraded. The toner of the present invention has good fluidity in spite of including such a small amount of the inorganic material. Therefore, high-resolution images can be provided for a long period of time even after a large amount of copies and prints are produced.

Specific examples of the release agent include, but are not limited to, carnauba wax, montan wax, and oxidized rice wax. These waxes can be used alone or in combination.

The carnauba wax preferably has a microcrystal structure and an acid value of not greater than 5 mgKOH/g. The dispersion diameter of the carnauba wax in a toner is preferably not greater than 1 μm.

As the montan wax, purified montan wax or mineral montan wax can be used, with a purified montan wax being preferred. The montan wax preferably has a microcrystal structure and an acid value of from 5 to 14 mgKOH/g.

The rice wax is obtained by oxidizing a rice bran wax with air. The rice wax preferably has an acid value of from 10 to 30 mgKOH/g.

Further, solid silicone varnishes, esters of higher fatty acids and higher alcohols, montan ester waxes, low-molecular-weight polypropylene waxes, and the like can be used as the release agent.

The release agent preferably has a volume average particle diameter of from 10 to 800 μm before being dispersed in the toner. When the volume average particle diameter is too small, the dispersion diameter of the release agent in the toner is too small, and therefore an offset problem is caused, wherein part of a fused toner image is adhered and transferred to the surface of a heat member and then the part of the toner image is re-transferred to an undesired portion of a sheet of a recording material. When the volume average particle diameter is too large, the dispersion diameter of the release agent in the toner is too large, and therefore a large amount of the wax is exposed to the surface of the toner. As a result, fluidity of the toner deteriorates and the release agent tends to adhere to inner walls of a developing device.

The dispersion diameter of the release agent in the toner is preferably from 0.1 to 1.0 μm, and more preferably from 0.1 to 0.5 μm. Thereby, the toner hardly contaminates a developing sleeve.

The volume average diameter of the release agent can be measured using a particle size distribution analyzer such as LA-920 (from Horiba, Ltd.).

The release agent preferably has a melting point of from 65 to 90° C. When the melting point is too low, toner blocking tends to occur. When the melting point is too high, the offset problem tends to occur when the temperature of a fixing roller is low.

The toner preferably includes the release agent in an amount of from 2.5 to 8% by weight, and more preferably from 4.0 to 7.0% by weight. Thereby, fixability of the toner increases. When the amount is too small, resistance to hot offset is not satisfactory, particularly when the release agent has a small dispersion diameter of from 0.1 to 0.5 μm in the toner. When the amount is too large, small toner particles tend to aggregate and contaminate a developing sleeve.

Specific examples of the colorants for use in the toner of the present invention include any known dyes and pigments such as carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, redlead, orangelead, cadmiumred, cadmiummercuryred, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, RhodamineLakeY, AlizarineLake, ThioindigoRedB, Thioindigo Maroon, Oil Red, Quinacridone Red, Pyrazolone Red, polyazo red, ChromeVermilion, BenzidineOrange, perynoneorange, Oil Orange, cobaltblue, ceruleanblue, AlkaliBlueLake, PeacockBlueLake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxaneviolet, AnthraquinoneViolet, ChromeGreen, zinc green, chromium oxide, viridian, emerald green, Pigment Green B, Naphthol Green B, GreenGold, AcidGreenLake, MalachiteGreen Lake, PhthalocyanineGreen, AnthraquinoneGreen, titaniumoxide, zinc oxide, and lithopone. These materials can be used alone or in combination.

The color of the above-mentioned colorants is not limited. For example, the above-mentioned colorants can be used as a black colorant and various colored colorants.

Specific examples of black colorants include, but are not limited to, carbon blacks (C. I. Pigment Black 7) such as furnace black, lamp black, acetylene black, and channel black; metallic materials such as copper, iron (C. I. Pigment Black 11), and titanium oxide; and organic pigments such as aniline black (C. I. Pigment Black 1).

Specific examples of magenta colorants include, but are not limited to, C. I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 48:1, 49, 50, 51, 52, 53, 53:1, 54, 55, 57, 57:1, 58, 60, 63, 64, 68, 81, 83, 87, 88, 89, 90, 112, 114, 122, 123, 163, 177, 179, 202, 206, 207, 209, and 211; C. I. Pigment Violet 19; and C. I. Vat Red 1, 2, 10, 13, 15, 23, 29, and 35.

Specific examples of cyan colorants include, but are not limited to, C. I. Pigment Blue 2, 3, 15, 15:1, 15:2, 15:3, 15:4, 15:6, 16, 17, and 60; C. I. Vat Blue 6; C. I. Acid Blue 45; copper phthalocyanine pigments in which phthalocyanine skeleton is substituted with 1 to 5 phthalimidemethyl groups; and Green 7 and 36.

Specific examples of yellow colorants include, but are not limited to, C. I. Pigment Yellow 0-16, 1, 2, 3, 4, 5, 6, 7, 10, 11, 12, 13, 14, 15, 16, 17, 23, 55, 65, 73, 74, 83, 97, 110, 151, 154, and 180; C. I. Vat Yellow 1, 3, and 20; and Orange 36.

The toner preferably includes the colorant in an amount of from 1 to 15% by weight, and more preferably from 3 to 10% by weight. When the amount is too small, coloring power of the toner deteriorates. When the amount is too large, the colorant cannot be well dispersed the toner, resulting in deterioration of coloring power and electric properties.

The colorant for use in the present invention can be combined with a resin to be used as a master batch. Specific examples of the resin for use in the master batch include, but are not limited to, the above-mentioned polyester-based resins, styrene polymers and substituted styrene polymers (e.g., polystyrene, poly-p-chlorostyrene, polyvinyltoluene), styrene copolymers (e.g., styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl α-chloro methacrylate copolymer, styrene-acrylonitrile copolymer, styrene-vinyl methyl ketone copolymer, styrene-butadiene copolymer, styrene-isoprene copolymer, styrene-acrylonitrile-indene copolymer, styrene-maleic acid copolymer, styrene-maleic acid ester copolymer), polymethyl methacrylate, polybutyl methacrylate, polyvinyl chloride, polyvinyl acetate, polyethylene, polypropylene, polyester, epoxy resin, epoxy polyol resin, polyurethane, polyamide, polyvinyl butyral, polyacrylic acid, rosin, modified rosin, terpene resin, aliphatic or alicyclic hydrocarbon resin, aromatic petroleum resin, chlorinated paraffin, and paraffin wax. These resins can be used alone or in combination.

The toner of the present invention preferably includes a charge controlling agent. The charge controlling agent may be internally or externally added to the toner. By including the charge controlling agent, the toner may have an appropriate charge quantity particularly suitable for use in a developing method in which the toner concentration is not controlled.

Both positive and negative charge controlling agents can be used as the charge controlling agent in the present invention.

Specific examples of the positive charge controlling agents include, but are not limited to, nigrosine compounds, modified products of metal salts of fatty acids, quaternary ammonium salts (e.g., tributylbenzylammonium-1-hydroxy-4-naphthosulfonic acid, tetrabutylammonium tetrafluoroborate), diorganotin oxides (e.g., dibutyltin oxide, dioctyltin oxide, dicyclohexyltin oxide), and diorganotin borates (e.g., dibutyltin borate, dioctyltin borate, dicyclohexyltin borate). These agents can be used alone or in combination. Among these agents, nigrosine compounds and quaternary ammonium salts are preferably used.

Specific examples of the negative charge controlling agents include, but are not limited to, organic metal compounds and chelate compounds such as aluminum acetylacetonate, iron(II) acetylacetonate, chromium 3,5-di-t-butylsalicylate, metal complexes of acetylacetone, metal complexes of monoazo compounds, and metal complexes of naphthoic acid and salicylic acid. Among these, metal complexes of monoazo compounds and metal complexes salicylic acid are preferably used.

The charge controlling agent is preferably used in a fine particle state. Specifically, fine particles of the charge controlling agent preferably has a number average particle diameter of not greater than 3 μm.

The content of the charge controlling agent is determined depending on the species of the binder resin used, and toner manufacturing method (such as dispersion method) used, and is not particularly limited. However, the content of the charge controlling agent is typically from 0.1 to 20 parts by weight, and preferably from 0.2 to 10 parts by weight, per 100 parts by weight of the binder resin included in the toner. When the content is too low, the toner has too small a charge quantity, which is not suitable for practical use. When the content is too high, the toner has too large a charge quantity, and thereby the electrostatic force of a developing roller attracting the toner increases, resulting in deterioration of the fluidity of the toner and image density of the toner images.

The toner may optionally include other components, if desired. For example, the toner may include a lubricant powder (e.g., TEFLON® powder, zinc stearate powder, polyvinylidene fluoride powder), an abrasive (e.g., ceriumoxide powder, silicon carbide powder, strontium titanate powder), a conductivity giving agent (e.g., carbon black powder, zinc oxide powder, tin oxide powder), a developability improving agent (e.g., white and/or black fine particles having the reverse polarity), and the like.

The toner of the present invention can be prepared by any known toner manufacturing methods such as pulverization methods, polymerization methods, dissolution suspension methods, and spray granulation methods. Among these, pulverization methods are preferably used in terms of dispersibility of colorant and productivity.

In the pulverization method, for example, toner components including a binder resin, a colorant, and the like are melt-kneaded, and then the melt-kneaded mixture is pulverized and classified to prepare a mother toner.

In the melt-kneading process, the toner components are mixed, and subsequently the mixture is melt-kneaded using a kneader. Specific examples of the kneaders include, but are not limited to, single-screw or double-screw continuous kneaders and batch kneaders using a roll mill. Specific examples of usable commercially available kneaders include, but are not limited to, TWIN SCREW EXTRUDER KTK from Kobe Steel, Ltd., TWIN SCREW COMPOUNDER TEM from Toshiba Machine Co., Ltd., MIRACLE K.C.K from Asada Iron Works Co., Ltd., TWIN SCREW EXTRUDER PCM from Ikegai Co., Ltd., and KOKNEADER from Buss Corporation. The melt-kneading process should be performed such that the molecular chain of the binder resin is not cut. In particular, the melt-kneading temperature should be determined considering the softening point of the binder resin. When the melt-kneading temperature is too much lower than the softening point of the binder resin, the molecular chain is cut. When the melt-kneading temperature is too much higher than the softening point of the binder resin, toner constituents cannot be well dispersed.

In the pulverization process, the kneaded mixture is pulverized. The kneaded mixture is preferably subjected to coarse pulverization at first, followed by fine pulverization. Suitable pulverization methods include a method in which the particles collide with a collision board in a jet stream; a method in which the particles collide with each other in a jet mill; and the particles are pulverized in a narrow gap formed between a mechanically rotating rotor and a stator; etc.

In the classification process, the pulverized particles are classified so as to have a desired particle diameter by removing fine particles. The classification can be performed using a cyclone, a decanter, a centrifugal separator, etc.

After the pulverization and classification processes, the particles are flowed into an airflow by centrifugal force so that a mother toner having a desired particle diameter is prepared.

The external additive is externally added to the mother toner by mixing the mother toner and the external additive using a mixer. The surfaces of the mother toner particles are covered with the external additive particles while aggregations of the external additive particles are pulverized. In order to improve durability of the resultant toner, it is important to uniformly and strongly adhere the external additive particles to the mother toner particles.

The toner of the present invention preferably has the following properties.

The toner of the present invention preferably has a weight average particle diameter of from 6.0 to 10.0 μm, more preferably from 6.0 to 8.0 μm, and much more preferably from 7.0 to 8.0 μm. When the weight average particle diameter is too small, charge quantity of the toner increases after a long period of use, resulting in deterioration of the resultant image density particularly in low humidity conditions. When the weight average particle diameter is too large, the resultant image quality deteriorates such that a fine 1200 dpi image has poor resolution and toner scattering is caused in background of the image.

The toner of the present invention preferably includes toner particles having a particle diameter not greater than 5 μm in an amount of from 20 to 80% by number, more preferably 40 to 80% by number, and much more preferably from 40 to 60% by number. Such a toner can produce high-definition and high-resolution images. When the amount of the toner particles having a particle diameter not greater than 5 μm is too large, fluidity of the toner deteriorates, resulting in occurrence of image density unevenness. When the amount of the toner particles having a particle diameter not greater than 5 μm is too small, the number of fine particles faithfully reproducing an electrostatic latent image decreases, resulting in deterioration of reproducibility of high-resolution images. When the toner includes a large amount of coarse particles, the resultant image density decreases particularly when an image consuming a large amount of toner is produced.

The weight average particle diameter and the amount of the toner particles having a particle diameter not greater than 5 μm can be measured using a particle diameter distribution analyzer such as MULTISIZER II (from Beckman Coulter K. K.), for example.

The toner of the present invention preferably has a glass transition temperature of from 40 to 70° C. When the glass transition temperature is too small, thermostable preservability of the resultant toner deteriorates. When the glass transition temperature is too high, low-temperature fixability of the resultant toner deteriorates.

The glass transition temperature can be measured based on JIS K7121 using a differential scanning calorimeter DSC-210 (from Seiko Instruments Inc.) at a temperature rising rate of 10° C./min, for example.

The color tone of the toner is not particularly limited. The toner may have at least one color selected from black, cyan, magenta, and yellow, and may include an appropriate colorant selected from the above-mentioned colorants.

### (Two-Component Developer)

The two-component developer of the present invention includes the toner of the present invention and a carrier.

As the carrier, any known carriers can be used. For example, magnetic core particles such as iron powder, ferrite powder, and magnetite powder; the above magnetic core particles having a cover layer on the surface thereof; and resin particles in which magnetic particles are dispersed, can be used. Among these, magnetic core particles and these magnetic core particles having a cover layer on the surface thereof are preferably used.

The cover layer includes a resin. Specific examples of the resins include, but are not limited to, polyolefin resins (e.g., polyethylene, polypropylene, chlorinated polyethylene, chlorosulfonated polyethylene), polyvinyl and polyvinylidene resins (e.g., polystyrene, polymethyl methacrylate, polyacrylonitrile, polyvinyl acetate, polyvinyl alcohol, polyvinyl butyral, polyvinyl chloride, polyvinyl carbazole, polyvinyl ether, polyvinyl ketone), vinyl chloride-vinyl acetate copolymer, fluorocarbon resins (e.g., polytetrafluoroethylene, polyvinyl fluoride, polyvinylidene fluoride, polychlorotrifluoroethylene), polyester, polyurethane, polycarbonate, amino resins (e.g., urea-formaldehyde resin), epoxy resin, and silicone resin. These resins can be used alone or in combination.

Specific examples of the silicone resins include, but are not limited to, silicone resins modified with an alkyd, a polyester, an epoxy, or an urethane; and straight silicone resins having the following formula (1) including organosiloxane bonds:

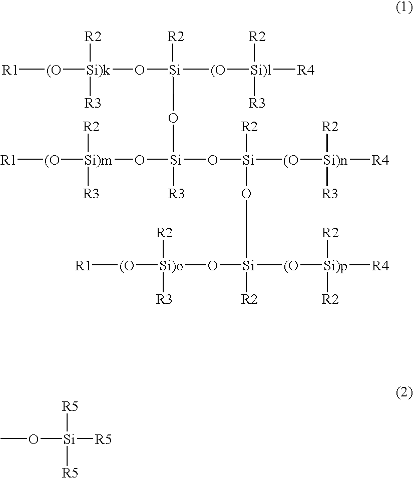

wherein R1 represents a hydrogen atom or an alkyl or phenyl group having 1 to 4 carbon atoms; each of R2 and R3 independently represents a hydrogen atom, an alkoxy group having 1 to 4 carbon atoms, a phenyl group, a phenoxy group, an alkenyl group having 2 to 4 carbon atoms, an alkenyloxy group having 2 to 4 carbon atoms, a hydroxyl group, a carboxyl group, an ethylene oxide group, a glycidyl group, or a group having the formula (2); each of R4 and R5 independently represents a hydroxyl group, a carboxyl group, an alkyl group having 1 to 4 carbon atoms, an alkoxy group having 1 to 4 carbon atoms, an alkenyl group having 2 to 4 carbon atoms, an alkenyloxy group having 2 to 4 carbon atoms, a phenyl group, or a phenoxy group; and each of k, 1, m, n, o, and p independently represents an integer of 1 or more.

The formulae (1) and (2) each may be unsubstituted or substituted with a substituent group such as amino group, hydroxyl group, carboxyl group, mercapto group, an alkyl group, phenyl group, ethylene oxide group, glycidyl group, and a halogen atom.

The cover layer may include a carbon black as a conductivity giving agent so that the carrier has a desired electrical resistivity. Specific examples of the carbon black include, but are not limited to, furnace black, acetylene black, and channel black. Among these carbon blacks, a mixture of furnace black and acetylene black is preferably used because the mixture is capable of effectively controlling conductivity of the carrier at small amount and giving good abrasion resistance to the cover layer.

The carbon black preferably has an average particle diameter of from 0.01 to 10 μm. The cover layer preferably includes the carbon black in an amount of from 2 to 30 parts by weight, and more preferably from 5 to 20 parts by weight, based on 100 parts by weight of the resin included in the cover layer.

The cover layer may include a silane coupling agent, a titanium coupling agent, and the like, to improve adhesiveness to the core and dispersibility of the conductivity giving agent. As the silane coupling agent, a compound having the following formula (3) is preferably used:

YRSiX₃ (3)

wherein X represent a hydrolysis group (e.g., chloro group, alkoxy group, acetoxy group, alkylamino group, propenoxy group) bound to silicon atom; Y represents an organic functional group (e.g., vinyl group, methacryl group, epoxy group, glycidoxy group, amino group, mercapto group) reacts with an organic matrix; and R represents an alkyl or alkylene group having 1 to 20 carbon atoms.

In order to obtain a negatively charged developer, an amino silane coupling agent having the formula (3) in which Y represents amino group is preferably used. In order to obtain a positively charged developer, an epoxy silane coupling agent having the formula (3) in which Y represents epoxy group is preferably used.

The cover layer can be formed by, for example, dissolving a silicone resin, etc., in an organic solvent to prepare a cover layer coating liquid, and then the cover layer coating liquid is uniformly coated on the core by known methods such as a dip coating method, a spray coating method, and a brush coating method. The coated core is then subjected to drying and baking.

Specific examples of the organic solvents include, but are not limited thereto, toluene, xylene, methyl ethyl ketone, methyl isobutyl ketone, and cellosolve butyl acetate.

The baking method can be either or both of an external heating method or an internal heating method. Specific baking methods include, but are not limited thereto, methods using a fixed electric furnace, a portable electric furnace, a rotary electric furnace, a burner furnace, and a microwave.

The cover layer preferably has a thickness of from 0.1 to 20 μm.

The carrier preferably has an average particle diameter of from 35 to 80 μm. The average particle diameter can be determined by, for example, a typical screening method or a method in which an image observed with an optical microscope including 200 to 400 randomly selected carrier particles are analyzed with an image analyzer.

Since the two-component developer of the present invention includes the toner of the present invention, the two-component developer has good environmental stability, temporal stability, and charge ability, resulting in stable production of high quality images.

The two-component developer of the present invention is used for any known image forming apparatuses using electrophotography, and preferably used for the following image forming apparatus of the present invention.

### (Image Forming Apparatus)

The image forming apparatus of the present invention includes an electrostatic latent image bearing member, an electrostatic latent image forming device, a developing device, a transfer device, and a fixing device, and optionally includes a discharge device, a cleaning device, a recycle device, a control device, and the like, if desired.

The image forming apparatus of the present invention forms an image by a method including an electrostatic latent image forming process, a developing process, a transfer process, and a fixing process, and optionally including a discharge process, a cleaning process, a recycle process, a control process, and the like, if desired.

In the electrostatic latent image forming process, an electrostatic latent image is formed on an electrostatic latent image bearing member.

The material, shape, structure, and size of the electrostatic latent image bearing member (hereinafter referred to as photoreceptor, photoconductor, image bearing member, etc.) are not particularly limited. A drum-like shaped image bearing member is preferably used. As for the material, inorganic photoreceptors including an amorphous silicon, selenium, etc., and organic photoreceptors including a polysilane, a phthalopolymethine, etc., can be used as the image bearing member. In terms of long life, inorganic photoreceptors including an amorphous silicon are preferably used.

The electrostatic latent image is formed by uniformly charging the surface of the electrostatic latent image bearing member, and subsequently irradiating the charged surface of the electrostatic latent image bearing member with a light beam containing image information, for example. The electrostatic latent image forming device includes a charger to uniformly charge the surface of the electrostatic latent image bearing member and an irradiator to irradiate the charged surface of the electrostatic latent image bearing member with a light beam containing image information, for example.

In the charging process, the charger applies a voltage to the surface of the electrostatic latent image bearing member.

As the charger, for example, known contact chargers such as a conductive or semi-conductive roller, a brush, a film, and a rubber blade, and known non-contact chargers such as corotron and scorotron using corona discharge can be used.

In the irradiating process, the charged surface of the electrostatic latent image bearing member is irradiated with a light beam containing image information by the irradiator.

Any known irradiators capable of irradiating the charged surface of the electrostatic latent image bearing member so that a latent image is formed thereon can be used. For example, irradiators using a radiation optical system, a rod lens array, a laser optical system, a liquid crystal shutter optical system, an LED optical system, etc., can be used.

In the present invention, the electrostatic latent image bearing member may be irradiated with a light beam containing image information from the backside thereof.

In the developing process, the electrostatic latent image is developed with the toner or developer of the present invention to form a toner image.

The toner image is formed by developing the electrostatic latent image with the toner or developer of the present invention by the developing device.

Any known developing devices capable of developing the electrostatic latent image with the toner or developer of the present invention can be used. For example, a developing device including a developer bearing member to rotatably bear a two-component developer on a surface thereof, internally containing a fixed magnetic field generating device; a first control member to control an amount of the two-component developer borne by the developer bearing member; a developer containing part to contain the two-component developer scraped off by the first control member; and a toner containing part to supply a toner to the developer bearing member, provided adjacent to the developer containing part, is preferably used. In the above-described developing device, the condition of contact between the toner and the carrier is changed according to the toner concentration in the two-component developer borne by the developer bearing member. Thereby, the amount of the toner incorporated in the two-component developer borne by the developer bearing member supplied from the toner containing part is controlled.

Further, the developer containing part preferably includes a second control member to control an increased amount of the two-component developer borne by the developer bearing member, provided on an upstream side from the first control member relative to a feed direction of the two-component developer borne by the developer bearing member while forming a gap between the developer bearing member.

In the transfer process, a toner image is transferred onto a recording medium. It is preferable that the toner image is firstly transferred onto an intermediate transfer member, and subsequently transferred onto the recording medium. It is more preferable that the transfer process includes a primary transfer process in which two or more monochrome toner images, preferably in full color, are transferred onto the intermediate transfer member to form a composite toner image and a secondary transfer process in which the composite toner image is transferred onto the recording medium.

The transfer process is performed by, for example, charging a toner image formed on the electrostatic latent image bearing member by the transfer device such as a transfer charger. The transfer device preferably includes a primary transfer device to transfer monochrome toner images onto an intermediate transfer member to form a composite toner image and a secondary transfer device to transfer the composite toner image onto a recording medium.

Any known transfer members can be used as the intermediate transfer member. For example, a transfer belt is preferably used.

The transfer device (such as the primary transfer device and the secondary transfer device) preferably includes a transferrer to separate the toner image from the electrostatic latent image bearing member to the recording medium. The transfer device may be used alone or in combination.

As the transferrer, a corona transferrer using corona discharge, a transfer belt, a transfer roller, a pressing transfer roller, an adhesion transferrer, etc., can be used.

As the recording medium, any known recording media (such as recording papers) can be used.

In the fixing process, a toner image transferred onto a recording medium is fixed thereon by the fixing device. Each of monochrome toner images may be independently fixed on the recording medium. Alternatively, a composite toner image in which monochrome toner images are superimposed may be fixed at once.

As the fixing device, known heat and pressure applying devices are preferably used. As the heat and pressure applying device, a combination of a heat applying roller and a pressure applying roller, a combination of a heat applying roller, a pressure applying roller, and a seamless belt, etc., can be used.

The heat and pressure applying device preferably heats an object to a temperature of from 80 to 200° C.

Any known optical fixing devices may be used alone or in combination with the above-mentioned fixing device in the fixing process of the present invention.

In the discharge process, charges remaining on the electrostatic latent image bearing member are removed by applying a discharge bias to the electrostatic latent image bearing member. The discharge process is preferably performed by a discharge device.

As the discharge device, any known dischargers capable of applying a discharge bias to the electrostatic latent image bearing member can be used. For example, a discharge lamp is preferably used.

In the cleaning process, toner particles remaining on the electrostatic latent image bearing member are removed by a cleaning device.

As the cleaning device, any known cleaners capable of removing toner particles remaining on the electrostatic latent image bearing member can be used. For example, a magnetic brush cleaner, an electrostatic brush cleaner, a magnetic roller cleaner, a blade cleaner, a brush cleaner, a web cleaner, etc. can be used.

In the recycle process, the toner particles removed in the cleaning process are recycled by a recycle device.

As the recycle device, any known feeding devices can be used, for example.

In the control process, each of the above-mentioned processes is controlled by a control device.

As the control device, any known controllers capable of controlling the operation of each of the devices can be used. For example, a sequencer, a computer, etc., can be used.

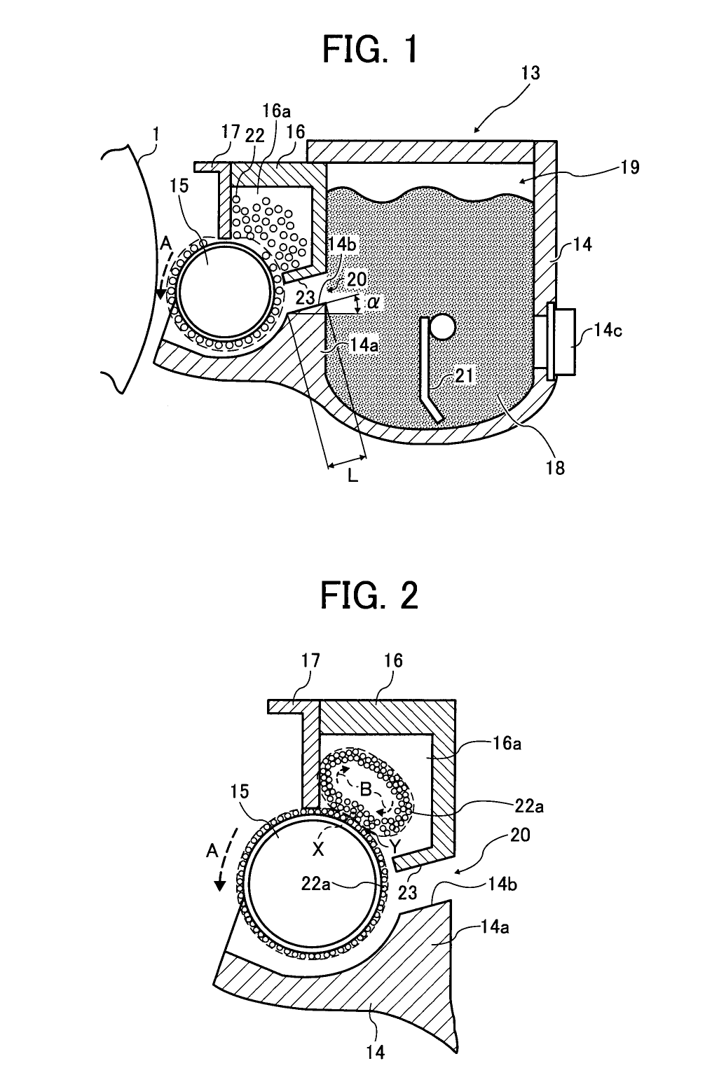

FIG. 1 is a schematic view illustrating an embodiment of a developing device for use in the image forming apparatus of the present invention. A developing device 13 is laterally provided on a side of a photoreceptor 1 serving as an electrostatic latent image bearing member. The developing device 13 includes a support casing 14, a developing sleeve 15 serving as a developer bearing member, a developer containing member 16, and a first doctor blade 17 serving as a developer control member.

The support casing 14 opens toward the photoreceptor 1 and internally forms a toner hopper 19 serving as a toner containing part containing a toner 18. The support casing 14 integrally supports the developer containing member 16 toward the photoreceptor 1 relative to the toner hopper 19. The developer containing member 16 forms a developer containing part 16a containing a developer 22 including the toner 18 and a magnetic carrier 22a consisting of magnetic carrier particles. Below the developer containing member 16, a projection 14a having a facing surface 14b is formed on the support casing 14 where facing the developer containing member 16. A space formed between the bottom side of the developer containing member 16 and the facing surface 14b forms a toner supply opening 20 to supply the toner 18.

A toner agitator 21 serving as a toner supply member rotated by a driving device (not shown) is provided in the toner hopper 19. The toner agitator 21 feeds the toner 18 contained in the toner hopper 19 toward the toner supply opening 20 while agitating the toner 18. A toner end detector 14c to detect a shortage of the toner 18 is provided on the opposite side of the photoreceptor 1 relative to the toner hopper 19.

The developing sleeve 15 is provided in a space formed between the photoreceptor 1 and the toner hopper 19. The developing sleeve 15 is rotated by a driving device (not shown) in a direction indicated by an arrow A. The developing sleeve 15 internally contains a magnet (not shown) serving as a magnetic field generating device in which the relative position thereof to the developing device 13 is unchangeable.

The developer containing member 16 integrally supports the first doctor blade 17 on the opposite of the support casing 14. The first doctor blade 17 is provided so that the tip thereof forms a constant gap between the outermost surface of the developing sleeve 15.

A second doctor blade 23 serving as a control member is provided on a portion of the developer containing member 16 adjacent to the toner supply opening 20. The base end of the second doctor blade 23 is integrally supported with the developer containing member 16 and the free end thereof is provided toward the center of the developing sleeve 15, in other words, in a direction preventing the feed of a layer of the developer 22 formed on the developing sleeve 15, so that the free end of the second doctor blade 23 forms a constant gap between the developing sleeve 15.

The developer containing part 16a is configured to have a satisfactory space to circulate the developer 22. The facing surface 14b is inclined from the toner hopper 19 toward the developing sleeve 15. Thereby, even if carrier particles fall down from the developer containing part 16a through a gap formed between the second doctor blade 23 and the developing sleeve 15, due to unevenness of the magnetic force distribution of the magnet (not shown) fixed inside the developing sleeve 15 and partial increase of the toner concentration in the developer 22, the fallen carrier particles may be received by the facing surface 14b, moved toward the developing sleeve 15, magnetically adhered to the developing sleeve 15, and resupplied to the developer containing part 16a again. Therefore, decrease of carrier particles contained in the developer containing part 16a is prevented, resulting in production of images without image density unevenness in an axial direction of the developing sleeve 15.

The facing surface 14b preferably has an inclination α of about 5 degrees. The facing surface 14b preferably has a length L of from 2 to 20 mm, and more preferably from 3 to 10 mm.

The toner 18 is supplied from the toner hopper 19 by the toner agitator 21 to the developer 22 borne by the developing sleeve 15 through the toner supply opening 20, and is transported to the developer containing part 16a. The developer 22 contained in the developer containing part 16a is transported to a point facing the outermost surface of the photoreceptor 1 by the developing sleeve 15, and only the toner 18 included in the developer 22 electrically binds to an electrostatic latent image formed on the photoreceptor 1. Thus, a toner image is formed on the photoreceptor 1.

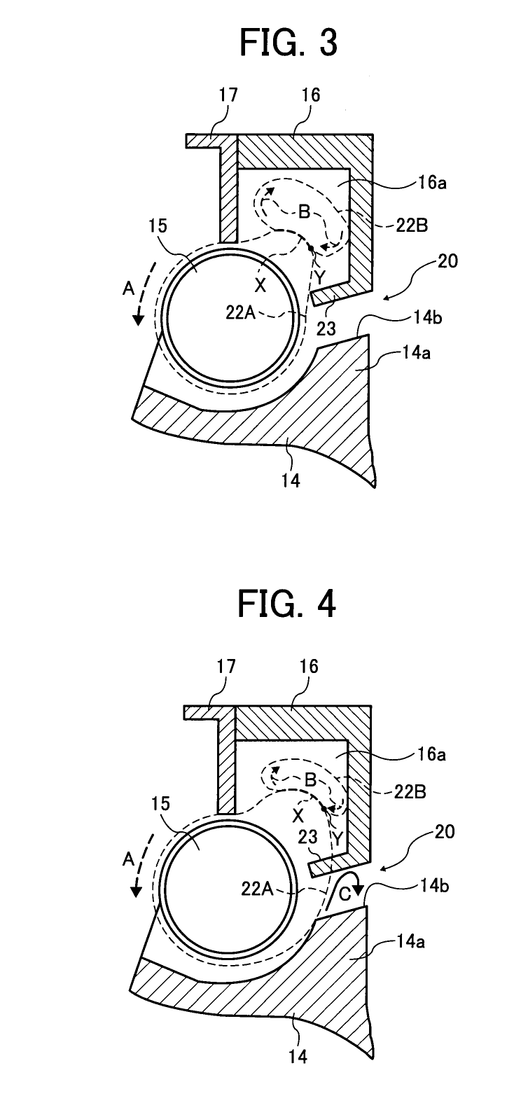

The behavior of the developer 22 at a time of forming a toner image will be explained. When an initial developer consisting of the magnetic carrier 22a is set in the developing device 13, some carrier particles magnetically adheres to the surface of the developing sleeve 15 and the other carrier particles are contained in the developer containing part 16a. As illustrated in FIG. 2, the carrier particles contained in the developer containing part 16a circulate in a direction indicated by an arrow B at a moving velocity of 1 mm/s or more due to rotation of the developing sleeve 15 having magnetic force in a direction indicated by an arrow A. Therefore, a boundary surface X is formed between the carrier particles magnetically adhered to the surface of the developing sleeve 15 and the carrier particles circulating in the developer containing part 16a.

When the toner 18 is set in the toner hopper 19, the toner 18 is supplied to the magnetic carrier 22a borne by the developing sleeve 15 through the toner supply opening 20. As a result, the developer 15 bears the developer 22 which is a mixture of the toner 18 and the magnetic carrier 22a. The developer 22 borne by the developing sleeve 15 is hereinafter referred to as a developer 22A.

The developer 22 is also contained in the developer containing part 16a. The developer 22 contained in the developer containing part 16a is hereinafter referred to as a developer 22B. The developer 22B acts on the developer 22A so that the transportation of the developer 22A is inhibited. In particular, when the toner 18 present on the surface of the developer 22A is transported to the boundary surface X, frictional force between the developers 22A and 22B decreases around the boundary surface X, resulting in deterioration of transportation capacity of the developer 22 around the boundary surface X. Therefore, the transport amount of the developer 22 around the boundary surface X decreases.

On the other hand, no force acts on the developer 22A present on an upstream side from a confluence point Y of the developers 22A and 22B relative to the rotation direction of the developing sleeve 15, to inhibit the transportation of the developer 22A. Therefore, the amount of the developer 22 transported to the confluence point Y and that transported to the boundary surface X get out of balance. As a result, the thickness of the layer of the developer 22A increases and the positions of the confluence point Y and the boundary surface X move upward, as illustrated in FIG. 3. Further, the thickness of the layer of the developer 22A also gradually increases after passing through the first doctor blade 17. The excessive developer 22A is scraped off by the second doctor blade 23.

When the developer 22A has a desired toner concentration after passing though the first doctor blade 17, the excessive developer 22A scraped off by the second doctor blade 23 forms a thick developer layer and blocks the toner supply opening 20, as illustrated in FIG. 4, resulting in completion of supplement (incorporation) of the toner 18. At this time, in the developer containing part 16a, the developer 22A has a large bulk because of having a large toner concentration. The internal space of the developer containing part 16a is thereby narrowed, resulting in decrease of the moving velocity of the developer 22B circulating in a direction indicated by an arrow B.

The developer 22A scraped off by the second doctor blade 23 and blocking the toner supply opening 20 moves in a direction indicated by an arrow C at a moving velocity of 1 mm/s or more, and is received by the facing surface 14b. Since the facing surface 14b is inclined toward the developing sleeve 15 at an inclination of α and has a predetermined length L, the moving developer 22 is prevented from falling into the toner hopper 19. Therefore, the amount of the developer 22 can be kept constant, resulting in constant self-control of the toner supplement all the time.

As mentioned above, the developer is capable of efficiently and constantly incorporating the toner, and the surface thereof does not deteriorate with time, in the image forming apparatus of the present invention. Therefore, the resultant image density hardly decreases even if an image consuming a large amount of toner is continuously produced, and images having a satisfactory image density and thin line reproducibility can be produced even in high-speed machines.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Synthesis Example 1

### Synthesis of Polyester Resin (P1)

In a reaction vessel equipped with a condenser tube, a stirrer, and a nitrogen inlet pipe, 2.5 mol of polyoxyethylene(2,2)-2,2-bis(4-hydroxyphenyl)propane, 1.5 mol of polyoxypropylene(2,2)-2,2-bis(4-hydroxyphenyl)propane, 1.5 mol of terephthalic acid, 1 mol of trimellitic acid, 1.5 mol of maleic acid, and 5 g of tin octylate are contained. The mixture is reacted for 10 hours at 230° C. under nitrogen airflow while removing the water generated, and subsequently reacted under a reduced pressure of from 5 to 20 mmHg. The mixture is then cooled to 180° C., and 0.8 mol of trimellitic anhydride is added thereto. The mixture is hermetically reacted for 2 hours under normal pressure. The product is cooled to room temperature and pulverized.

Thus, a non-linear polyester resin (P1) having a glass transition temperature of 64° C. is prepared.

### Synthesis Example 2

### Synthesis of Polyester Resin (P2)

In a reaction vessel equipped with a condenser tube, a stirrer, and a nitrogen inlet pipe, 0.5 mol of polyoxyethylene(2,2)-2,2-bis(4-hydroxyphenyl)propane, 2.5 mol of polyoxypropylene(2,2)-2,2-bis(4-hydroxyphenyl)propane, 0.9 mol of isophthalic acid, 2.1 mol of fumaric acid, and 4 g of tin octylate are contained. The mixture is reacted for 10 hours at 230° C. under nitrogen airflow while being agitated, and subsequently reacted under a reduced pressure of from 5 to 20 mmHg. The product is cooled to room temperature and pulverized.

Thus, a polyester resin (P2) having a glass transition temperature of 60° C. is prepared.

### Synthesis Example 3

### Synthesis of Polyester Resin (P3)

In a reaction vessel equipped with a condenser tube, a stirrer, and a nitrogen inlet pipe, 1 mol of 1,3-propyleneglycol, 1.5 mol of 1,4-propylene glycol polyoxyethylene(2,2)-(2,2)-bis(4-hydroxyphenyl)propane, 1.5 mol of pentaerythritol, 1 mol of citraconic acid, 2 mol of itaconic acid, 0.5 mol of trimellitic acid, and 5 g of tin octylate are contained. The mixture is reacted for 10 hours at 230° C. under nitrogen airflow while removing the water generated, and subsequently reacted under a reduced pressure of from 5 to 20 mmHg. The mixture is then cooled to 180° C., and 1 mol of trimellitic anhydride is added thereto. The mixture is hermetically reacted for 2 hours under normal pressure. The product is cooled to room temperature and pulverized.

Thus, a non-linear polyester resin (P3) having a glass transition temperature of 58° C. is prepared.

### Synthesis Example 4

### Synthesis of Polyester Resin (P4)

The procedure for preparing the polyester resin (P1) in Synthesis Example 1 is repeated except that 5 g of the tin octylate is replaced with 8 g of tin oxalate.

Thus, a polyester resin (P4) having a glass transition temperature of 63° C. is prepared.

### Synthesis Example 5

### Synthesis of Hybrid Resin (P5)

In a dropping funnel, 25 mol of styrene and 2 mol of butyl methacrylate (both serving as a monomer capable of addition polymerization), and 0.8 mol of t-butyl hydroperoxide (serving as a polymerization initiator) are contained. In a flask equipped with a stainless stirrer, a flow-down condenser, a nitrogen inlet pipe, and a thermometer, 15 mol of terephthalic acid and 3 mol of adipic acid (both serving a monomer capable of both addition polymerization and condensation polymerization); 2 mol of trimellitic anhydride, 15 mol of bisphenol A (2,2) propylene oxide, and 5 mol of bisphenol A (2,2) ethylene oxide (all serving as a monomer capable of condensation polymerization); and 5 mol of tin(II) dioleate (serving as an esterification catalyst) are contained. The mixture in the flask is agitated at 150° C. under nitrogen atmosphere, while the mixture contained in the dropping funnel is dropped into the flask over a period of 5 hours. The mixture is aged for 5 hours at 150° C., and subsequently heated to 230° C. to react.

Thus, a hybrid resin (P5) having a glass transition temperature of 55° C. is prepared.

### Synthesis Example 6

### Synthesis of Hybrid Resin (P6)

In a dropping funnel, 30 mol of styrene (serving as a monomer capable of addition polymerization) and 0.8 mol of t-butyl hydroperoxide (serving as a polymerization initiator) are contained. In a flask equipped with a stainless stirrer, a flow-down condenser, a nitrogen inlet pipe, and a thermometer, 20 mol of terephthalic acid (serving a monomer capable of both addition polymerization and condensation polymerization); 1 mol of trimellitic anhydride, 10 mol of bisphenol A (2,2) propylene oxide, and 10 mol of bisphenol A (2,2) ethylene oxide (all serving as a monomer capable of condensation polymerization); and 3 mol of tin octylate (serving as an esterification catalyst) are contained. The mixture in the flask is agitated at 150° C. under nitrogen atmosphere, while the mixture contained in the dropping funnel is dropped into the flask over a period of 5 hours. The mixture is aged for 5 hours at 150° C., and subsequently heated to 230° C. to react.

Thus, a hybrid resin (P6) having a glass transition temperature of 57° C. is prepared.

### Synthesis Example 7

### Synthesis of Polyester Resin (P7)

The procedure for preparing the polyester resin (P1) in Synthesis Example 1 is repeated except that 5 g of the tin octylate is replaced with 5 g of dibutyl tin oxide.

Thus, a polyester resin (P7) having a glass transition temperature of 61° C. is prepared.

### Synthesis Example 8

### Synthesis of Polyester Resin (P8)

In a reaction vessel equipped with a condenser tube, a stirrer, and a nitrogen inlet pipe, 2 mol of PO 2 mol adduct of bisphenol A, 3 mol of EO 2 mol adduct of bisphenol A, 3 mol of terephthalic acid, 2 mol of maleic anhydride, and 5 parts of titanyl isophthalate (serving as a polycondensation catalyst) are contained. The mixture is reacted for 10 hours at 230° C. under nitrogen airflow while removing the water generated, and subsequently reacted under a reduced pressure of from 5 to 20 mmHg. The product is cooled to room temperature and pulverized.

Thus, a non-linear polyester resin (P8) having a glass transition temperature of 62° C. is prepared.

### Synthesis Example 9

### Synthesis of Polyester Resin (P9)

In a reaction vessel equipped with a condenser tube, a stirrer, and a nitrogen inlet pipe, 2 mol of 1,2,3,6-hexanetetrol, 3 mol of dipentaerythritol, 4 mol of sebacic acid, 1 mol of succinic acid, and 10 parts of titanium carboxylate (serving as a polycondensation catalyst) are contained. The mixture is reacted for 10 hours at 230° C. under nitrogen airflow while removing the water generated, and subsequently reacted under a reduced pressure of from 5 to 20 mmHg. The mixture is then cooled to 180° C., and 1 mol of trimellitic anhydride is added thereto. The mixture is hermetically reacted for 2 hours under normal pressure. The product is cooled to room temperature and pulverized.

Thus, a non-linear polyester resin (P9) having a glass transition temperature of 54° C. is prepared.

### Example 1

### Preparation of Toner

The following components are mixed using a HENSCHEL MIXER.

| | |
|---|---|
| Polyester resin (P1) | 100 parts |
| Charge controlling agent | 5 parts |
| (Zinc (III) complex of salicylic acid, BONTRON E-84 from | |
| Orient Chemical Industries, Ltd.) | |
| Magnetite particles | 22 parts |
| Polypropylene | 3 parts |
| (VISCOL 550P from Sanyo Chemical Industries, Ltd.) | |

The mixture is kneaded using an extruder at a preset temperature of 180° C. The kneaded mixture is cooled to solidify. The cooled mixture is coarsely pulverized by a cutter mill, and subsequently finely pulverized by a mechanical pulverizer. The pulverized mixture is classified using a multi-segment classifier using Coanda effect. Thus, a mother toner is prepared.

Next, 100 parts of the mother toner is mixed with 0.5 parts of a hydrophobized silica (R202 from Degussa Japan Co., Ltd.) treated with dimethyl silicone oil and 0.5 parts of a hydrophobized silica (AEROSIL 300 from Nippon Aerosil Co., Ltd.) treated with hexamethyl disilazane using HENSCHEL MIXER.

Thus, a toner (1) is prepared. The toner (1) has a weight average particle diameter of 6.1 μm and includes toner particles having a particle diameter not greater than 5 μm in an amount of 79.8% by number.

### (Preparation of Magnetic Carrier)

The following components are mixed for 20 minutes using a HOMOMIXER to prepare a cover layer liquid.

| | |
|---|---|
| Silicone resin | 100 parts |
| (Organo straight silicone) | |
| Toluene | 100 parts |
| γ-(2-Aminoethyl) aminopropyl trimethoxysilane | 5 parts |
| Carbon black | 10 parts |

The cover layer liquid is applied to the surfaces of 1,000 parts of spherical magnetite particles having a particle diameter of 50 μm using a fluidized bed coating device. Thus, a magnetic carrier is prepared.

### (Preparation of Two-Component Developer)

Next, 90 parts of the magnetic carrier prepared above and 10 parts of the toner (1) are mixed using a TURBULA MIXER. Thus, a two-component developer (1) is prepared.

### Example 2

The following components are mixed using a HENSCHEL MIXER.

| | |
|---|---|
| Polyester resin (P2) | 50 parts |
| Polyester resin (P3) | 50 parts |
| Charge controlling agent | 3 parts |
| (Chromium-containing azo dye, BONTRON S-34 from Orient | |
| Chemical Industries, Ltd.) | |
| Magnetite particles | 17 parts |
| Synthesized ester wax | 8 parts |
| (WEP-1 from NOF Corporation) | |

The mixture is kneaded using an extruder at a preset temperature of 180° C. The kneaded mixture is cooled to solidify. The cooled mixture is coarsely pulverized by a cutter mill, and subsequently finely pulverized by a mechanical pulverizer. The pulverized mixture is classified using a multi-segment classifier using Coanda effect. Thus, a mother toner is prepared.

Next, 100 parts of the mother toner is mixed with 0.3 parts of a hydrophobized silica (RY200 from Degussa Japan Co., Ltd.) treated with dimethyl silicone oil and 0.1 parts of a hydrophobized silica (AEROSIL 380 from Nippon Aerosil Co., Ltd.) treated with hexamethyl disilazane using a HENSCHEL MIXER.

Thus, a toner (2) is prepared. The toner (2) has a weight average particle diameter of 8.5 μm and includes toner particles having a particle diameter not greater than 5 μm in an amount of 40.0% by number.

The procedure for preparing the two-component developer (1) in Example 1 is repeated except for replacing the toner (1) with the toner (2). Thus, a two-component developer (2) is prepared.

### Example 3

The following components are mixed using a HENSCHEL MIXER.

| | |
|---|---|
| Polyester resin (P2) | 40 parts |
| Polyester resin (P3) | 60 parts |
| Charge controlling agent | 3 parts |
| (Chromium-containing azo dye, BONTRON S-34 from Orient | |
| Chemical Industries, Ltd.) | |
| Magnetite particles | 28 parts |
| Synthesized ester wax | 5 parts |
| (WEP-1 from NOF Corporation) | |

The mixture is kneaded using an extruder at a preset temperature of 180° C. The kneaded mixture is cooled to solidify. The cooled mixture is coarsely pulverized by a cutter mill, and subsequently finely pulverized by a mechanical pulverizer. The pulverized mixture is classified using a multi-segment classifier using Coanda effect. Thus, a mother toner is prepared.

Next, 100 parts of the mother toner is mixed with 0.3 parts of a hydrophobized silica (RY200 from Degussa Japan Co., Ltd.) treated with dimethyl silicone oil using a HENSCHEL MIXER.

Thus, a toner (3) is prepared. The toner (3) has a weight average particle diameter of 10.0 μm and includes toner particles having a particle diameter not greater than 5 μm in an amount of 20.0% by number.

The procedure for preparing the two-component developer (1) in Example 1 is repeated except for replacing the toner (1) with the toner (3). Thus, a two-component developer (3) is prepared.

### Example 4

The following components are mixed using a HENSCHEL MIXER.

| | |
|---|---|
| Polyester resin (P4) | 100 parts |
| Charge controlling agent | 5 parts |
| (Nigrosine, BONTRON PBN-04 from Orient | |
| Chemical Industries, Ltd.) | |
| Magnetite particles | 22 parts |
| Synthesized ester wax | 6 parts |
| (WEP-5 from NOF Corporation) | |

The mixture is kneaded using an extruder at a preset temperature of 180° C. The kneaded mixture is cooled to solidify. The cooled mixture is coarsely pulverized by a cutter mill, and subsequently finely pulverized by a mechanical pulverizer. The pulverized mixture is classified using a multi-segment classifier using Coanda effect. Thus, a mother toner is prepared.

Next, 100 parts of the mother toner is mixed with 1.0 parts of a hydrophobized silica (RY200 from Degussa Japan Co., Ltd.) treated with dimethyl silicone oil and 0.5 parts of a hydrophobized silica (AEROSIL 300CF from Nippon Aerosil Co., Ltd.) treated with hexamethyl disilazane using a HENSCHEL MIXER.

Thus, a toner (4) is prepared. The toner (4) has a weight average particle diameter of 5.5 μm and includes toner particles having a particle diameter not greater than 5 μm in an amount of 85.0% by number.

The procedure for preparing the two-component developer (1) in Example 1 is repeated except for replacing the toner (1) with the toner (4). Thus, a two-component developer (4) is prepared.

### Example 5

The procedure for preparing the mother toner in Example 4 is repeated except for changing the conditions of pulverization and classification.

Next, 100 parts of the thus prepared mother toner is mixed with 0.2 parts of a hydrophobized silica (RY200 from Degussa Japan Co., Ltd.) treated with dimethyl silicone oil and 0.1 parts of a hydrophobized silica (AEROSIL 300CF from Nippon Aerosil Co., Ltd.) treated with hexamethyl disilazane using a HENSCHEL MIXER.

Thus, a toner (5) is prepared. The toner (5) has a weight average particle diameter of 10.5 μm and includes toner particles having a particle diameter not greater than 5 μm in an amount of 12% by number.

The procedure for preparing the two-component developer (1) in Example 1 is repeated except for replacing the toner (1) with the toner (5). Thus, a two-component developer (5) is prepared.

### Example 6

The following components are mixed using a HENSCHEL MIXER.

| | |
|---|---|
| Polyester resin (P1) | 80 parts |
| Polyester resin (P2) | 20 parts |
| Polyester resin (P5) | 10 parts |
| Charge controlling agent | 5 parts |
| (SPIELON BLACK TRH from Hodogaya Chemical Co., Ltd.) | |
| Magnetite particles | 20 parts |
| Release agent | 5 parts |
| (SANWAX 151-P from Sanyo Chemical Industries, Ltd.) | |

The mixture is kneaded using an extruder at a preset temperature of 180° C. The kneaded mixture is cooled to solidify. The cooled mixture is coarsely pulverized by a cutter mill, and subsequently finely pulverized by a mechanical pulverizer. The pulverized mixture is classified using a multi-segment classifier using Coanda effect. Thus, a mother toner is prepared.

Next, 100 parts of the mother toner is mixed with 1.0 parts of a hydrophobized silica (R202 from Degussa Japan Co., Ltd.) treated with dimethyl silicone oil and 0.5 parts of a hydrophobized silica (HVK-21 from Clariant Japan K. K.) treated with hexamethyl disilazane using a HENSCHEL MIXER.

Thus, a toner (6) is prepared. The toner (6) has a weight average particle diameter of 7.2 μm and includes toner particles having a particle diameter not greater than 5 μm in an amount of 38% by number.

The procedure for preparing the two-component developer (1) in Example 1 is repeated except for replacing the toner (1) with the toner (6). Thus, a two-component developer (6) is prepared.

### Example 7

The following components are mixed using a HENSCHEL MIXER.

| | |
|---|---|
| Polyester resin (P1) | 80 parts |
| Polyester resin (P2) | 20 parts |
| Polyester resin (P5) | 2 parts |
| Charge controlling agent | 5 parts |
| (SPIELON BLACK TRH from Hodogaya Chemical Co., Ltd.) | |
| Magnetite particles | 20 parts |
| Release agent | 8 parts |
| (SANWAX 151-P from Sanyo Chemical Industries, Ltd.) | |

The mixture is kneaded using an extruder at a preset temperature of 180° C. The kneaded mixture is cooled to solidify. The cooled mixture is coarsely pulverized by a cutter mill, and subsequently finely pulverized by a mechanical pulverizer. The pulverized mixture is classified using a multi-segment classifier using Coanda effect. Thus, a mother toner is prepared.

Next, 100 parts of the mother toner is mixed with 1.0 parts of a hydrophobized silica (R202 from Degussa Japan Co., Ltd.) treated with dimethyl silicone oil and 1.5 parts of a hydrophobized silica (HVK-21 from Clariant Japan K. K.) treated with hexamethyl disilazane using a HENSCHEL MIXER.

Thus, a toner (7) is prepared. The toner (7) has a weight average particle diameter of 6.2 μm and includes toner particles having a particle diameter not greater than 5 μm in an amount of 75% by number.

The procedure for preparing the two-component developer (1) in Example 1 is repeated except for replacing the toner (1) with the toner (7). Thus, a two-component developer (7) is prepared.

### Example 8

The following components are mixed using a HENSCHEL MIXER.

| | |
|---|---|
| Polyester resin (P1) | 80 parts |
| Polyester resin (P2) | 20 parts |
| Polyester resin (P5) | 30 parts |
| Charge controlling agent | 5 parts |
| (SPIELON BLACK TRH from Hodogaya Chemical Co., Ltd.) | |
| Magnetite particles | 20 parts |
| Release agent | 8 parts |
| (SANWAX 151-P from Sanyo Chemical Industries, Ltd.) | |

The mixture is kneaded using an extruder at a preset temperature of 180° C. The kneaded mixture is cooled to solidify. The cooled mixture is coarsely pulverized by a cutter mill, and subsequently finely pulverized by a mechanical pulverizer. The pulverized mixture is classified using a multi-segment classifier using Coanda effect. Thus, a mother toner is prepared.

Next, 100 parts of the mother toner is mixed with 0.5 parts of a hydrophobized silica (R202 from Degussa Japan Co., Ltd.) treated with dimethyl silicone oil and 0.5 parts of a hydrophobized silica (HVK-21 from Clariant Japan K. K.) treated with hexamethyl disilazane using a HENSCHEL MIXER.

Thus, a toner (8) is prepared. The toner (8) has a weight average particle diameter of 7.8 μm and includes toner particles having a particle diameter not greater than 5 μm in an amount of 70% by number.

The procedure for preparing the two-component developer (1) in Example 1 is repeated except for replacing the toner (1) with the toner (8). Thus, a two-component developer (8) is prepared.

### Example 9

The following components are mixed using a HENSCHEL MIXER.

| | |
|---|---|
| Polyester resin (P3) | 40 parts |
| Polyester resin (P2) | 60 parts |
| Polyester resin (P6) | 30 parts |
| Charge controlling agent | 2 parts |
| (Salicylic acid complex, BONTRON E-304 from | |
| Orient Chemical Industries, Ltd.) | |
| Magnetite particles | 20 parts |
| Release agent | 8 parts |
| (SANWAX 151-P from Sanyo Chemical Industries, | |
| Ltd.) | |

The mixture is kneaded using an extruder at a preset temperature of 180° C. The kneaded mixture is cooled to solidify. The cooled mixture is coarsely pulverized by a cutter mill, and subsequently finely pulverized by a mechanical pulverizer. The pulverized mixture is classified using a multi-segment classifier using Coanda effect. Thus, a mother toner is prepared.

Next, 100 parts of the mother toner is mixed with 0.5 parts of a hydrophobized silica (R202 from Degussa Japan Co., Ltd.) treated with dimethyl silicone oil and 0.5 parts of a hydrophobized silica (HVK-21 from Clariant Japan K. K.) treated with hexamethyl disilazane using a HENSCHEL MIXER.

Thus, atoner (9) is prepared. The toner (9) has a weight average particle diameter of 6.1 μm and includes toner particles having a particle diameter not greater than 5 μm in an amount of 78% by number.

The procedure for preparing the two-component developer (1) in Example 1 is repeated except for replacing the toner (1) with the toner (9). Thus, a two-component developer (9) is prepared.

### Comparative Example 1

The following components are mixed using a HENSCHEL MIXER.

| | |
|---|---|
| Polyester resin (P7) | 100 parts |
| Charge controlling agent | 5 parts |
| (SPIELON BLACK TRH from Hodogaya Chemical Co., Ltd.) | |
| Magnetite particles | 20 parts |
| Release agent | 5 parts |
| (SANWAX 151-P from Sanyo Chemical Industries, Ltd.) | |

The mixture is kneaded using an extruder at a preset temperature of 180° C. The kneaded mixture is cooled to solidify. The cooled mixture is coarsely pulverized by a cutter mill, and subsequently finely pulverized by a mechanical pulverizer. The pulverized mixture is classified using a multi-segment classifier using Coanda effect. Thus, a mother toner is prepared.

Next, 100 parts of the mother toner is mixed with 1.0 parts of a hydrophobized silica (R202 from Degussa Japan Co., Ltd.) treated with dimethyl silicone oil using a HENSCHEL MIXER.

Thus, a comparative toner (C1) is prepared. The comparative toner (C1) has a weight average particle diameter of 6.5 μm and includes toner particles having a particle diameter not greater than 5 μm in an amount of 50% by number.

The procedure for preparing the two-component developer (1) in Example 1 is repeated except for replacing the toner (1) with the comparative toner (C1). Thus, a comparative two-component developer (C1) is prepared.

### Comparative Example 2

The procedure for preparing the toner (C1) in Comparative Example 1 is repeated except that the amount of the magnetite particles are changed from 20 parts to 50 parts. Thus, a comparative toner (C2) is prepared.

The procedure for preparing the two-component developer (1) in Example 1 is repeated except for replacing the toner (1) with the comparative toner (C2). Thus, a comparative two-component developer (C2) is prepared.

### Comparative Example 3

Hundred parts of the mother toner prepared in Comparative Example 1 is mixed with 1.0 parts of a hydrophobized silica (HVK-21 from Clariant Japan K. K.) treated with hexamethyl disilazane using a HENSCHEL MIXER. Thus, a comparative toner (C3) is prepared.

The procedure for preparing the two-component developer (1) in Example 1 is repeated except for replacing the toner (1) with the comparative toner (C3). Thus, a comparative two-component developer (C3) is prepared.

### Comparative Example 4

The following components are mixed using a HENSCHEL MIXER.

| | |
|---|---|
| Polyester resin (P8) | 70 parts |
| Polyester resin (P9) | 30 parts |
| Charge controlling agent | 5 parts |
| (Salicylic acid complex, BONTRON E-304 from | |
| Orient Chemical Industries, Ltd.) | |
| Magnetite particles | 8 parts |
| Release agent | 5 parts |
| (SANWAX 151-P from Sanyo Chemical Industries, | |
| Ltd.) | |

The mixture is kneaded using an extruder at a preset temperature of 180° C. The kneaded mixture is cooled to solidify. The cooled mixture is coarsely pulverized by a cutter mill, and subsequently finely pulverized by a mechanical pulverizer. The pulverized mixture is classified using a multi-segment classifier using Coanda effect. Thus, a mother toner is prepared.

Next, 100 parts of the mother toner is mixed with 2.0 parts of a hydrophobized silica (HVK-21 from Clariant Japan K. K.) treated with hexamethyl disilazane using a HENSCHEL MIXER.

Thus, a comparative toner (C4) is prepared. The toner comparative toner (C4) has a weight average particle diameter of 7.2 μm and includes toner particles having a particle diameter not greater than 5 μm in an amount of 58% by number.

The procedure for preparing the two-component developer (1) in Example 1 is repeated except for replacing the toner (1) with the comparative toner (C4). Thus, a comparative two-component developer (C4) is prepared.

### Measurement of Toner Properties

Toner properties of the above-prepared toners are measured as follows.
(1) Particle Diameter Distribution

The particle diameter distribution of a toner is measured using an instrument COULTER COUNTER TA-II (from Beckman Coulter K. K.). The measuring method is as follows:

(1) 0.1 to 5 ml of a surfactant (an alkylbenzene sulfonate) is included as a dispersant in 100 to 150 ml of an electrolyte (i.e., 1% NaCl aqueous solution including a first grade sodium chloride such as ISOTON-II from Coulter Electrons Inc.);

(2) 2 to 20 mg of a toner is added to the electrolyte and dispersed using an ultrasonic dispersing machine for about 1 to 3 minutes to prepare a toner suspension liquid;

(3) the weight and the number of the toner particles are measured by the above instrument using an aperture of 100 μm to determine weight and number distribution thereof; and

(4) the weight average particle diameter and the ratio of toner particles having a particle diameter not greater than 5 μm are determined.

The channels include 13 channels as follows: from 2.00 to less than 2.52 μm; from 2.52 to less than 3.17 μm; from 3.17 to less than 4.00 μm; from 4.00 to less than 5.04 μm; from 5.04 to less than 6.35 μm; from 6.35 to less than 8.00 μm; from 8.00 to less than 10.08 μm; from 10.08 to less than 12.70 μm; from 12.70 to less than 16.00 μm; from 16.00 to less than 20.20 μm; from 20.20 to less than 25.40 μm; from 25.40 to less than 32.00 μm; and from 32.00 to less than 40.30 μm. Namely, particles having a particle diameter of from not less than 2.00 μm to less than 40.30 μm can be measured.
(2) Rheological Properties

Rheological properties of a toner are measured using a rheometer RDA-II (from Rheometric Scientific, Inc.). The measurement conditions are as follows.

Geometry set: parallel plate having a diameter of 7.9 mm

Sample: a heated and melted sample is formed into a columnar shape having a diameter of about 8 mm and a height of from 2 to 5 mm

Measurement frequency: 0.1 Hz

Measurement temperature: 70 to 150° C.

Measurement strain: set the initial value to 0.1% and measured by automatic measurement mode

Elongation correction of sample: by automatic measurement mode
(3) Glass Transition Temperature

The glass transition temperature (Tg) of a toner is measured using a differential scanning calorimeter DSC210 (from Seiko Instruments Inc.) at a temperature rising rate of 10° C./min, based on JIS K7121.
(4) Magnetic Properties

Magnetic properties of a toner are measured using a magnetization measuring instrument BHU-60 (from Riken Denshi Co., Ltd.). A cell having an inner diameter of 7 mm and a height of 10 mm is charged with a toner, and a hysteresis curve is obtained by sweeping at a magnetic filed of 5 kOe. The saturated magnetization is determined from the hysteresis curve.

### Evaluation

Each of the above-prepared two-component developers is set in an image forming apparatus IMAGIO MF200 (from Ricoh Co., Ltd.) including the developing device illustrated in FIG. 1, and an endurance test in which about 100,000 printings are produced is performed. After the endurance test is finished, the following evaluations are performed.
(1) Image Density

The image densities of randomly selected 3 portions in the upper, central, and bottom parts, respectively (i.e., a total of 9 portions), of an image are measured using a Macbeth reflective densitometer. The 9 image densities are averaged.
(2) Density Unevenness

Density unevenness is evaluated by a difference between the maximum image density and the minimum image density among the above-measured 9 image densities, and is graded as follows.

Very good: less than 0.1

Good: not less than 0.1 and less than 0.2

Average: not less than 0.2 and less than 0.5

Poor: not less than 0.5
(3) Resolution

Line images in which 2.0, 2.2, 2.5, 2.8, 3.2, 3.6, 4.0, 4.5, 5.0, 5.6, 6.3, and 7.1 vertical and horizontal lines are equidistantly paralleled in a gap of 1 mm, respectively, are produced. The produced images are visually observed whether or not the lines are faithfully reproduced. The resolution is evaluated by the maximum number of the lines per 1 mm which are faithfully reproduced.
(4) Controllability of Image Density

Twenty sheets of a 100% solid image having an image density of 1.6 are continuously produced. The controllability of image density is evaluated by the difference in image density between the first sheet and the last sheet, and is graded as follows.

Very good: less than 0.1

Good: not less than 0.1 and less than 0.2

Average: not less than 0.2 and less than 0.5

Poor: not less than 0.5
(5) Toner Adherence to Developing Sleeve

The developing sleeve of the image forming apparatus is visually observed whether or not toner particles are adhered. The level of the toner adherence is graded as follows.

Good: No toner particle is adhered.

Average: Toner particles are adhered, but possible to remove by scraping.

Poor: Toner particles are fused, and impossible to remove by scraping.
(6) Fog

An image produced is visually observed whether or not fog is caused. The level of the fog is graded as follows.

Good: Fog is not caused.

Average: Fog is slightly caused.

Poor: Fog is seriously caused.
(7) Minimum Fixable Temperature

Fixed images, having 0.80 to 0.90 mg/cm²of a toner thereon, are produced while varying (i.e., decreasing in stages) the temperature of the heater of the fixing device. A mending tape (from Sumitomo 3M Limited) is adhered to each of the fixed images and a pressure of 2 kg is applied thereto. Subsequently, the mending tape is slowly peeled off therefrom. The image density is measured by a Macbeth densitometer before the mending tape is adhered to the fixed image and after the mending tape is peeled off therefrom. The fixing ratio is calculated from the following equation:

Fixing ratio (%)=D_{A}/D_{B}×100

wherein D_{B} represents the image density measured before the mending tape is adhered to a fixed image and D_{A} represents the image density measured after the mending tape is peeled off therefrom.

The minimum fixable temperature is evaluated by the temperature at which the fixing ratio becomes 80% or lower.

The measurement results of toner properties are shown in Table 1. The evaluation results are shown in Tables 2 and 3.

TABLE 1

| | Particle Diameter | | Rheological | | | | |
|---|---|---|---|---|---|---|---|
| | Distribution | | properties | | | | |
| | Dw⁽¹⁾ | Ratio⁽²⁾ | G′ | G″ | | Tg | Magnetization⁽³⁾ |
| | (μm) | (% by number) | (Pa) | (Pa) | tan δ | (°) | (emu/g) |
| Ex. 1 | 6.1 | 79.8 | 1.66 × 10⁶ | 2.12 × 10⁶ | 1.28 | 65 | 17 |
| Ex. 2 | 8.5 | 40.0 | 7.61 × 10⁶ | 9.51 × 10⁶ | 1.25 | 59 | 10 |
| Ex. 3 | 10.0 | 20.0 | 1.05 × 10⁷ | 7.35 × 10⁶ | 0.70 | 58 | 25 |
| Ex. 4 | 5.5 | 84.8 | 1.12 × 10⁶ | 1.03 × 10⁶ | 0.92 | 62 | 18 |
| Ex. 5 | 10.5 | 12.0 | 1.12 × 10⁶ | 1.03 × 10⁶ | 0.92 | 62 | 19 |
| Ex. 6 | 6.5 | 68.0 | 9.09 × 10⁶ | 9.24 × 10⁶ | 1.02 | 58 | 20 |
| Ex. 7 | 6.2 | 75.0 | 9.22 × 10⁶ | 9.53 × 10⁶ | 1.03 | 62 | 21 |
| Ex. 8 | 7.8 | 55.0 | 8.66 × 10⁶ | 7.01 × 10⁶ | 0.81 | 58 | 18 |
| Ex. 9 | 6.1 | 78.0 | 6.92 × 10⁶ | 8.25 × 10⁶ | 1.19 | 58 | 18 |
| Comp. | 6.5 | 50.0 | 2.32 × 10⁵ | 1.41 × 10⁵ | 0.61 | 60 | 20 |
| Ex. 1 | | | | | | | |
| Comp. | 6.4 | 52.0 | 7.66 × 10⁶ | 1.11 × 10⁷ | 1.45 | 60 | 30 |
| Ex. 2 | | | | | | | |
| Comp. | 6.3 | 52.0 | 2.85 × 10⁵ | 1.65 × 10⁵ | 0.58 | 60 | 20 |
| Ex. 3 | | | | | | | |
| Comp. | 7.2 | 58 | 4.2 × 10⁴ | 2.2 × 10⁴ | 0.52 | 60 | 7 |
| Ex. 4 | | | | | | | |

⁽¹⁾Dw: Weight average particle diameter
⁽²⁾Ratio of toner particles having a particle diameter of not greater than 5 μm
⁽³⁾Magnetization in a magnetic filed of 5 kOe

TABLE 2

| | Image | Density | Resolution | Controllability of |
|---|---|---|---|---|
| | Density | Unevenness | (lines per 1 mm) | Image Density |
| Ex. 1 | 1.48 | Good | 7.1 | Good |
| Ex. 2 | 1.42 | Very good | 6.3 | Good |
| Ex. 3 | 1.40 | Very good | 5.6 | Very good |
| Ex. 4 | 1.49 | Good | 7.1 | Good |
| Ex. 5 | 1.41 | Good | 5.6 | Good |
| Ex. 6 | 1.42 | Very good | 7.1 | Very good |
| Ex. 7 | 1.38 | Good | 7.1 | Good |
| Ex. 8 | 1.45 | Good | 7.1 | Very good |
| Ex. 9 | 1.19 | Good | 7.1 | Very good |
| Comp. | 1.23 | Average | 7.1 | Average |
| Ex. 1 | | | | |
| Comp. | 1.12 | Average | 7.1 | Average |
| Ex. 2 | | | | |
| Comp. | 1.05 | Poor | 7.1 | Poor |
| Ex. 3 | | | | |
| Comp. | 1.11 | Poor | 7.1 | Poor |
| Ex. 4 | | | | |

TABLE 3

| | Toner Adherence | | |
|---|---|---|---|
| | to Developing | | Minimum Fixable |
| | Sleeve | Fog | Temperature (° C.) |
| Ex. 1 | Average | Average | 120 |
| Ex. 2 | Average | Average | 125 |
| Ex. 3 | Good | Good | 130 |
| Ex. 4 | Average | Average | 120 |
| Ex. 5 | Good | Average | 130 |
| Ex. 6 | Good | Good | 120 |
| Ex. 7 | Average | Average | 120 |
| Ex. 8 | Good | Average | 135 |
| Ex. 9 | Good | Average | 120 |
| Comp. | Average | Average | 120 |
| Ex. 1 | | | |
| Comp. | Good | Average | 150 |
| Ex. 2 | | | |
| Comp. | Average | Poor | 120 |
| Ex. 3 | | | |
| Comp. | Poor | Poor | 125 |
| Ex. 4 | | | |

This document claims priority and contains subject matter related to Japanese Patent Application No. 2007-054574, filed on Mar. 5, 2007, the entire contents of which are incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A toner, comprising:
a binder resin comprising a polyester resin comprising an inorganic tin(II) compound as a catalyst;
a magnetic material; and
a hydrophobized particulate inorganic material,
wherein the toner has a magnetization of from 10 to 25 emu/g in a magnetic field of 5 kOe, and
wherein the toner has a tan δ, which is a ratio of a loss elastic modulus (G″) to a storage elastic modulus (G′), of from 0.7 to 1.3 when measured by a rheometer at a frequency of 0.1 Hz and a temperature 30° C. higher than a glass transition temperature of the toner.

2. The toner according to claim 1, wherein the hydrophobized particulate inorganic material is treated with a silicone oil.

3. The toner according to claim 1, wherein the toner has a weight average particle diameter of from 6.0 to 10.0 μm and includes toner particles having a particle diameter not greater than 5 μm in an amount of from 20 to 80% by number.

4. The toner according to claim 1, wherein the toner has a weight average particle diameter of from 6.0 to 8.0 μm and includes toner particles having a particle diameter not greater than 5 μm in an amount of from 40 to 80% by number.

5. The toner according to claim 1, further comprising a release agent,
wherein the binder resin comprises a hybrid resin comprising a vinyl resin unit and a polyester resin unit comprising an inorganic tin(II) compound as a catalyst, and
wherein the following relationship is satisfied:
1/2B≦A≦3B
wherein A represents an amount of the hybrid resin included in the toner and B represents an amount of the release agent included in the toner.

6. The toner according to claim 1, wherein the inorganic tin(II) compound is tin octylate.

7. A two-component developer, comprising the toner according to claim 1 and a carrier.

8. The two-component developer according to claim 7, wherein the carrier comprises:
a core material; and
a cover layer located overlying the core material and comprising a silicone resin.

9. The two-component developer according to claim 7, wherein the hydrophobized particulate inorganic material is treated with a silicone oil.

10. The two-component developer according to claim 7, wherein the toner has a weight average particle diameter of from 6.0 to 10.0 μm and includes toner particles having a particle diameter not greater than 5 μm in an amount of from 20 to 80% by number.

11. The two-component developer according to claim 7, wherein the toner has a weight average particle diameter of from 6.0 to 8.0 μm and includes toner particles having a particle diameter not greater than 5 μm in an amount of from 40 to 80% by number.

12. The two-component developer according to claim 7, wherein the toner further comprises a release agent,
wherein the binder resin comprises a hybrid resin comprising a vinyl resin unit and a polyester resin unit comprising an inorganic tin(II) compound as a catalyst, and
wherein the following relationship is satisfied:
1/2B≦A≦3B
wherein A represents an amount of the hybrid resin included in the toner and B represents an amount of the release agent included in the toner.

13. The two-component developer according to claim 7, wherein the inorganic tin(II) compound is tin octylate.

14. An image forming apparatus, comprising:
an electrostatic latent image bearing member to bear an electrostatic latent image;
an electrostatic latent image forming device to form the electrostatic latent image on the electrostatic latent image bearing member;
a developing device to develop the electrostatic latent image with a toner to form a toner image;
a transfer device to transfer the toner image onto a recording medium; and
a fixing device to fix the toner image on the recording medium,
wherein the developing device comprises:
a developer bearing member to rotatably bear the two-component developer according to claim 7 on a surface thereof, internally containing a fixed magnetic field generating device;
a first control member to control an amount of the two-component developer borne by the developer bearing member;
a developer containing part to contain the two-component developer scraped off by the first control member, comprising:
a second control member to control an increased amount of the two-component developer borne by the developer bearing member, provided on an upstream side from the first control member relative to a feed direction of the two-component developer borne by the developer bearing member while forming a gap between the developer bearing member; and
a toner containing part to supply a toner to the developer bearing member, provided adjacent to the developer containing part.

15. The image forming apparatus according to claim 14, wherein the carrier comprises:
a core material; and
a cover layer located overlying the core material and comprising a silicone resin.

16. The image forming apparatus according to claim 14, wherein the hydrophobized particulate inorganic material is treated with a silicone oil.

17. The image forming apparatus according to claim 14, wherein the toner has a weight average particle diameter of from 6.0 to 10.0 μm and includes toner particles having a particle diameter not greater than 5 μm in an amount of from 20 to 80% by number.

18. The image forming apparatus according to claim 14, wherein the toner has a weight average particle diameter of from 6.0 to 8.0 μm and includes toner particles having a particle diameter not greater than 5 μm in an amount of from 40 to 80% by number.

19. The image forming apparatus according to claim 14, wherein the toner further comprises a release agent,
wherein the binder resin comprises a hybrid resin comprising a vinyl resin unit and a polyester resin unit comprising an inorganic tin(II) compound as a catalyst, and
wherein the following relationship is satisfied:
1/2B≦A≦3B
wherein A represents an amount of the hybrid resin included in the toner and B represents an amount of the release agent included in the toner.

20. The image forming apparatus according to claim 14, wherein the inorganic tin(II) compound is tin octylate.
